(19) United States
(12) Patent Application Publication
(10) Pub. No.: US 2025/0301095 A1
(43) Pub. Date: Sep. 25, 2025

(54) STORAGE MEDIUM STORING PROGRAM THAT ENABLES COLOR SETTING, CONTROL METHOD, AND INFORMATION PROCESSING APPARATUS

(71) Applicant: CANON KABUSHIKI KAISHA, Tokyo (JP)

(72) Inventor: HIROYA YAMAMOTO, Ibaraki (JP)

(21) Appl. No.: 19/085,772

(22) Filed: Mar. 20, 2025

(30) Foreign Application Priority Data
Mar. 21, 2024 (JP) 2024-044805

(51) Int. Cl. H04N 1/60; H04N 1/00

(52) U.S. Cl. CPC H04N 1/6027; H04N 1/0044

(57) ABSTRACT

A non-transitory computer-readable storage medium storing a program for supporting a general-purpose program which can be commonly used for scanners of a plurality of makers. The program causes a computer to display a setting reception screen for receiving setting of colors expressing an image read by the scanner, and output a reading instruction for causing the scanner to read the image under the color setting received on the setting reception screen.

### BACKGROUND OF THE INVENTION

### Field of the Invention

The present invention relates to a storage medium storing a program that enables color setting, a control method, and an information processing apparatus.

### Description of the Related Art

To a scanning device (scanner) that performs image reading, i.e. scanning, a host computer (information processing apparatus) that is capable of processing information between the same and the scanning device is communicably connected. As control software for controlling the scanning device, for example, a scan driver installed from the scanning device into the host computer is used. With this scan driver, it is possible to provide a scan instruction from the host computer to the scanning device. In the host computer, an operating system (OS) as basic software is installed in advance. The scan driver is configured according to specifications defined by the OS and can operate when called from the OS. Further, the scan driver is different for each vendor that supplies a scanning device, i.e. a model specific driver which is suitable on a scanning device basis.

In recent years, in Windows (registered trademark), a standard class driver (hereinafter sometimes referred to as the “standard driver”) is provided, which can be commonly used even for scanning devices supplied from a plurality of different vendors, respectively. The standard driver is incorporated in the OS in advance. Then, by connecting a desired scanning device to a host computer having the OS incorporating the standard driver, the standard driver can be used. This makes it possible to omit installation of a model-specific scan driver. Further, the standard driver is assumed to be configured to enable designation of a scan function of the scanning device according to scan function information generated based on information acquired from the scanning device. This makes it possible to designate a scan function for each scanning device by one standard driver.

The standard driver can be commonly used for the scanning devices of a plurality of different vendors, and hence, for example, there is a case where it is impossible to cause a scanning device of a predetermined vendor to execute part of functions of this scanning device. Japanese Laid-Open Patent Publication (Kokai) No. 2021-033526 discloses a program that extends a print function of a print service which can be used for general purpose regardless of a model or vendor of the image forming apparatus. With this, by operating a print setting screen adapted to an individual image forming apparatus on a model basis and on a vendor basis, it is possible to cause the image forming apparatus to execute a print function which cannot be executed if only by the print service which can be used for general purpose.

However, the standard driver has a problem that even when desired to perform setting of colors expressing an image scanned by the scanning device, this color setting cannot be performed.

### SUMMARY OF THE INVENTION

The present invention provides a storage medium storing a program that enables setting of colors expressing an image scanned by a scanner, a control method, and an information processing apparatus.

In a first aspect of the present invention, there is provided a non-transitory computer-readable storage medium storing a program for supporting a general-purpose program which can be commonly used for scanners of a plurality of makers, wherein the program causes a computer to display a setting reception screen for receiving setting of colors expressing an image read by the scanner, and output a reading instruction for causing the scanner to read the image under the color setting received on the setting reception screen.

In a second aspect of the present invention, there is provided a control method of performing control to support a general-purpose program which can be commonly used for scanners of a plurality of makers, including displaying a setting reception screen for receiving setting of colors expressing an image read by the scanner, and outputting a reading instruction for causing the scanner to read the image under the color setting received on the setting reception screen.

According to the present invention, it is possible to perform the setting of colors expressing an image scanned by a scanner.

Further features of the present invention will become apparent from the following description of exemplary embodiments (with reference to the attached drawings).

### BRIEF DESCRIPTION OF THE DRAWINGS

FIG. 1 is a block diagram showing a hardware configuration of a scan system according to a first embodiment.

FIGS. 2A and 2B are block diagrams each showing a software configuration of the scan system.

FIGS. 3A to 3C are diagrams each showing an example of a screen displayed on a display section of the scan system.

FIG. 4 is a flowchart of a process performed by a scan function-extending unit, for editing scan function information.

FIGS. 5A to 5C are diagrams each showing an example of a list of the scan information.

FIG. 6 is a sequence diagram showing a process executed between a scan application, general-purpose scan software, an extension application, and a scanning device, after the scan application receives a scan setting instruction.

FIG. 7 is a flowchart of a process performed by the extension application.

FIG. 8 is a flowchart of a process performed by the scanning device.

FIG. 9 is a sequence diagram showing a process executed, in a second embodiment, between the scan application, the general-purpose scan software, the extension application, and the scanning device, after the scan application receives a scan setting instruction.

FIG. 10 is a sequence diagram showing a process executed, in a third embodiment, between the scan application, the general-purpose scan software, the extension application, and the scanning device, after the scan application receives a scan setting instruction.

FIG. 11 is a flowchart of a process performed by the extension application.

FIGS. 12A to 12D are diagrams associated with scan information in a fourth embodiment.

FIGS. 13A to 13C are diagrams associated with scan information in a fifth embodiment.

FIGS. 14A to 14C are diagrams associated with scan information in a sixth embodiment.

FIGS. 15A to 15D are diagrams associated with scan information in a seventh embodiment.

FIGS. 16A to 16D are diagrams associated with scan information in an eighth embodiment.

FIGS. 17A and 17B are diagrams each showing an example of a screen displayed on the display section of the scan system according to a ninth embodiment.

FIGS. 18A to 18C are diagrams each showing an example of a screen displayed on the display section of the scan system according to a tenth embodiment.

### DESCRIPTION OF THE EMBODIMENTS

The present invention will now be described in detail below with reference to the accompanying drawings showing embodiments thereof. The configuration described in the following embodiments is given only by way of example, and is by no means intended to limit the scope of the present invention. For example, components of the configuration of the present invention can be replaced with desired components which can exhibit the same function. Further, desired components can be added. Further, two or more desired components (features) of the embodiments can be combined.

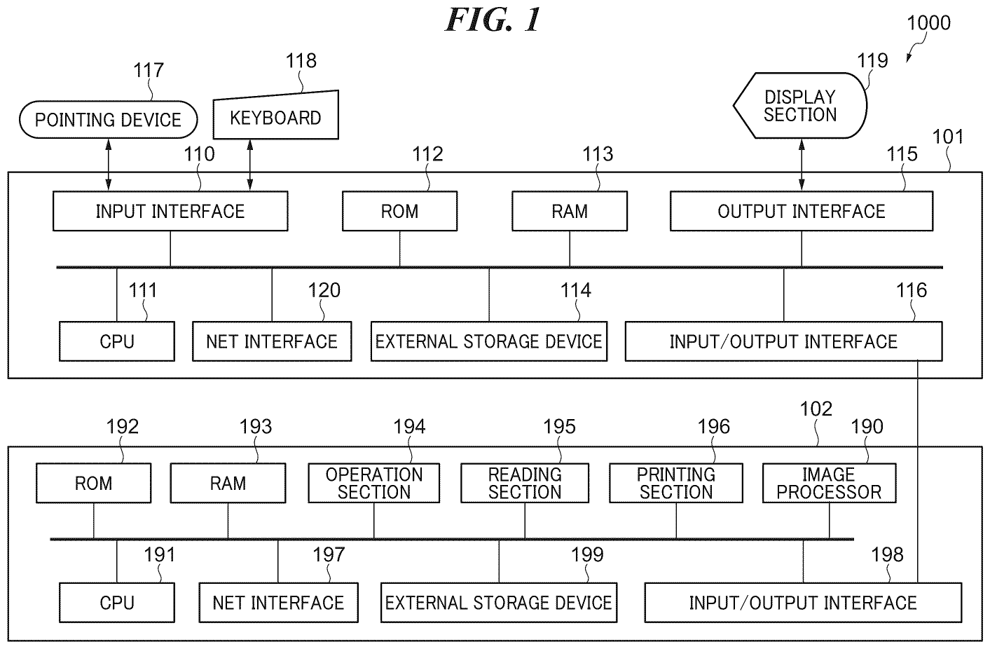

A first embodiment will be described below with reference to FIGS. 1 to 8.

FIG. 1 is a block diagram showing a hardware configuration of a scan system according to the first embodiment. As shown in FIG. 1, the scan system, denoted by reference numeral 1000, includes a host computer 101, a scanning device (scanner) 102, a pointing device 117, a keyboard 118, and a display section 119, and these are communicably connected to each other. The host computer 101 is an information processing apparatus and includes an input interface 110, a central processing unit (CPU) 111, a read only memory (ROM) 112, a random access memory (RAM) 113, an external storage device (storage medium) 114, an output interface 115, an input/output interface 116, and a network (NET) interface 120. Note that although as the host computer 101, for example, a desktop-type personal computer can be used, this is not limitative, but for example, a laptop-type personal computer, a tablet terminal, and a smartphone can be used.

The CPU 111 is a computer that executes e.g. programs stored in the ROM 112 and the external storage device 114. Note that in the present embodiment, the CPU 111 is capable of executing functions and processing of the host computer 101 by performing processing according to a program code stored in the ROM 112. In the ROM 112, an initialization program is stored. In the external storage device 114, an application program group, an operating system (OS), print data generation software, and a variety of other data items are stored. Note that in the present embodiment, as the OS, Windows (registered trademark) 11 of Microsoft (registered trademark) has been installed in the host computer 101. The external storage device 114 is not particularly limited, but for example, a hard disk drive (HDD) or a solid state drive (SSD) can be used. The RAM 113 is used e.g. as a work memory when a variety of programs stored in the external storage device 114 are executed, and the variety of programs can operate in the host computer 101. To the input interface 110, the pointing device 117 and the keyboard 118 as input devices are connected. To the output interface 115, the display section 119 as a display device is connected. On the display section 119, for example, a scan setting screen 300A and a detailed setting screen 300C, described hereinafter, are displayed. The NET interface 120 performs control to transfer data to and from an external apparatus via a network. To the input/output interface 116, the scanning device 102 is connected. This enables the host computer 101 to communicate with the scanning devices 102 of a plurality of makers, i.e. process information between the host computer 101 and the scanning devices 102 of the plurality of makers regardless of the maker of the scanning device 102. The host computer 101 and the scanning device 102 can be wired connected or can be wirelessly connected.

The scanning device 102 includes an image processor 190, a CPU 191, a ROM 192, a RAM 193, an operation section 194, a reading section 195, a printing section 196, a NET interface 197, an input/output interface 198, and an external storage device 199. The CPU 191 is a computer that executes e.g. programs stored in the ROM 192 and the external storage device 199 and performs centralized control of the scanning device 102. The ROM 192 is a memory for storing the programs. The RAM 193 is a memory for temporarily storing a program and image data. On the operation section 194, a variety of operation instructions can be provided to the scanning device 102. The reading section 195 reads an image from an original. The printing section 196 prints an image on a sheet based on image data generated by reading an image from an original in the reading section 195. Note that the printing section 196 can be omitted. The NET interface 197 performs control to transfer data to and from an external apparatus via a network. To the input/output interface 198, the host computer 101 is connected. To the image processor 190, for example, image data generated by reading an image from an original in the reading section 195 is input. Then, the image processor 190 performs various types of edit processing operations on the image data.

The scanning device 102 is not particularly limited insofar as it is an apparatus having an image reading function, i.e. a scan function, but for example, a multi-function peripheral (MFP) can be used. Further, in a case where the MFP is used as the scanning device 102, printing performed by the MFP is printing using the electrophotographic method in the present embodiment but is not limited to this, and, for example, printing using the inkjet method can be performed. Further, although in the present embodiment, the host computer 101 and the scanning device 102 are separately configured, this is not limitative. For example, the host computer 101 and the scanning device 102 can be configured as an integrated apparatus.

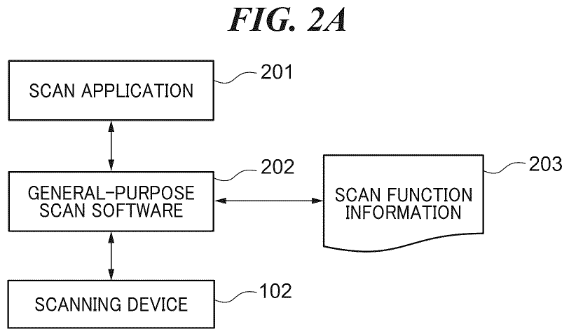

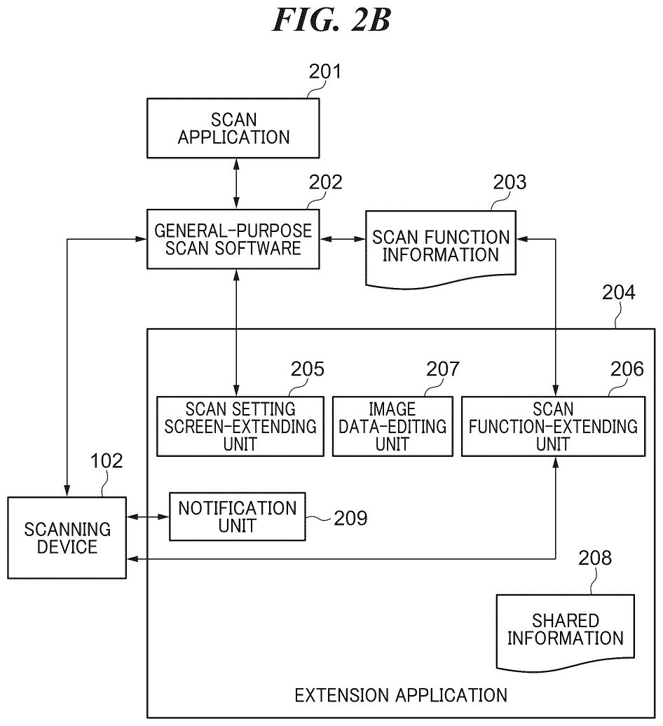

FIGS. 2A and 2B are block diagrams each showing a software configuration of the scan system. FIG. 2A is a diagram showing a general configuration in a case where an extension application (program) 204 is not associated with general-purpose scan software (general-purpose program) 202 and the scanning device 102. FIG. 2B is a diagram showing a configuration in a case where the extension application 204 is associated with the general-purpose scan software 202 and the scanning device 102. The general-purpose scan software 202 is a general-purpose program which can be commonly used for the scanning devices 102 of a plurality of makers, for example, when scanning (image reading) is performed. That is, the general-purpose scan software 202 is a general-purpose program for generating and outputting an instruction which can be executed and interpreted by the scanning devices 102 of the plurality of makers. The general-purpose scan software 202 is installed in the OS in advance. The extension application 204 supports, i.e. assists the general-purpose scan software 202. In the present embodiment, the extension application 204 is an extension program (program for executing a control method) which can extend functions which cannot be executed by the general-purpose scan software 202 for the scanning device 102, but is not limited to this. For example, the extension application 204 can be a program which improves the convenience of functions which can be executed by the general-purpose scan software 202 for the scanning device 102. The extension application 204 is stored e.g. in the external storage device 114 together with the OS (the general-purpose scan software 202). With this, the host computer 101 has the general-purpose scan software 202 and the extension application 204.

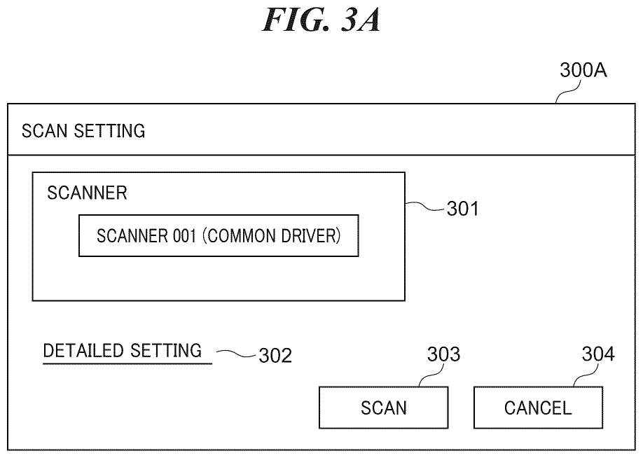

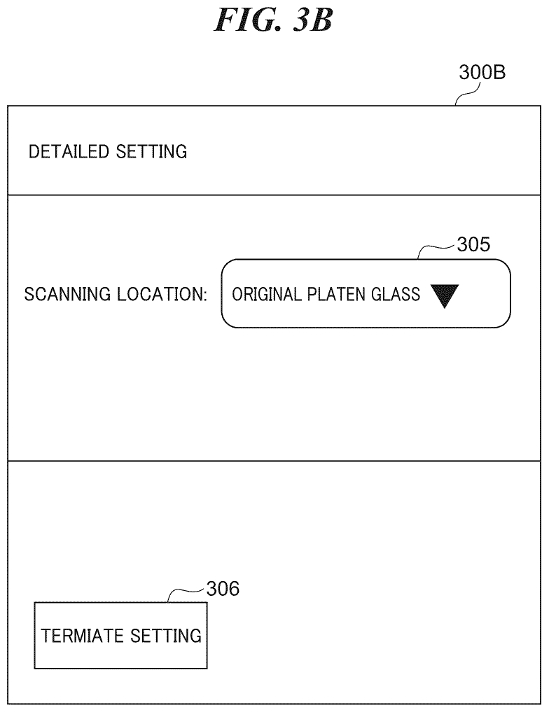

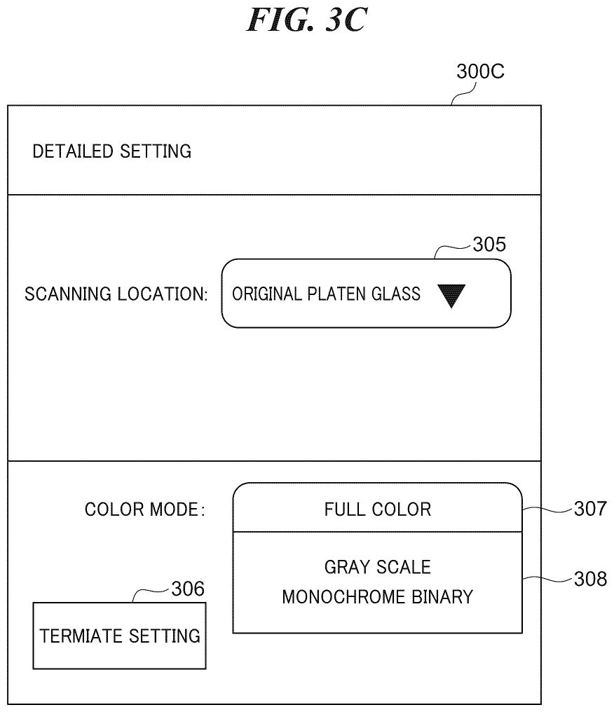

First, referring to FIG. 2A, the configuration in the case where the extension application 204 is not associated with general-purpose scan software 202 and the scanning device 102 will be described. A scan application 201 is software for tanking in contents (image data) generated by scanning performed by the scanning device 102. The scan application 201 is not particularly limited, but for example, a document generation application and an image editing application are used. The scan application 201 issues a scan instruction to the OS e.g. upon receipt of a scan request from a user. The scan instruction includes scan setting information for instructing operations of the general-purpose scan software 202 and the scanning device 102. To issue a scan instruction, the scan application 201 can display the scan setting screen 300A (see FIG. 3A) on the display section 119, provided by one of the general-purpose scan software 202, the OS, and the scan application 201. Further, when a control 302 in the scan setting screen 300A is operated (pressed), the scan application 201 can display a detailed setting screen 300B (see FIG. 3B) or the detailed setting screen 300C (see FIG. 3C) on the display section 119. The scan setting screen 300A to the detailed setting screen 300C will be described hereinafter. The scan setting screen 300A includes a setting item indicating a scan function which can be set according to capabilities information acquired by the general-purpose scan software 202, i.e. information which can be set as the scan setting, and a control item indicating its setting. The capabilities information refers to information related to the capabilities of the scanning device 102 for performing scan. Further, with this capabilities information, it is also possible to determine whether or not information which enables the display of the detailed setting screen 300C is included. Then, as a result of this determination, if it is determined that the information which enables the display of the detailed setting screen 300C is included, the detailed setting screen 300C can be displayed. On the other hand, if it is determined that the information which enables the display of the detailed setting screen 300C is not included, the display of the detailed setting screen 300C is inhibited.

Scan function information 203 is data indicating all scan functions which can be set, settings of these scan functions, and a scan function describing e.g. an exclusive relation between settings. The scan function information 203 is included in a configuration file of the general-purpose scan software 202 and is arranged in the external storage device 114 as an unchangeable file. Alternatively, the scan function information 203 is dynamically generated by the general-purpose scan software 202. Specifically, the general-purpose scan software 202 acquires attribute data of the scanning device 102 from the scanning device 102. The general-purpose scan software 202 generates the scan function information 203 according to attribute information in the attribute data. Note that in a case where the scan function information 203 is dynamically generated as described above, the scan information 203 can be edited. Further, the attribute data of the scanning device 102 includes the attribute information indicating the functions which can be designated in the scanning device 102 (capabilities of the scanning device 102) and settings associated with the attribute information, and these are stored in the RAM 113.

With this configuration, the general-purpose scan software 202 enables a user to designate a scan function which can be used in the scanning device 102 according to the scanning device 102 connected to the host computer 101. With this, regardless of the scanning device 102, i.e. even in a case where the scanning device 102 having a different function or the scanning device 102 developed by a different scanner maker is connected, it is possible to designate a scan function which can be used in the connected scanning device 102. Note that in the present embodiment, the general-purpose scan software 202 is a standard class driver that executes scanning based on a standard scan protocol called Mopria (registered trademark). Specifically, the general-purpose scan software 202 is not a scan driver specific to a model of the scanning device 102 but is a standard class driver which can be commonly used for scanning devices of scanner makers, without depending on a specific scanner maker. Further, the general-purpose scan software 202 acquires the capabilities information of the scanning device 102 and generates the scan function information 203 based on the acquired information.

Further, the general-purpose scan software 202 can be associated with the extension application 204. This enables the general-purpose scan software 202 to execute a function which is not supported by the general-purpose scan software 202. For example, the general-purpose scan software 202 cannot receive a setting of colors (hereinafter simply referred to as the “color setting”) expressing a read image read by the scanning device 102. That is, the general-purpose scan software 202 does not support the color setting. This is because the color setting is a function uniquely executed by the scanning device 102 manufactured by a predetermined scanner maker. The extension application 204 can extend functions of the general-purpose scan software 202 such that functions which cannot be caused to be executed by the host computer 101 can be caused to be executed. Although in the present embodiment, the general-purpose scan software 202 cannot perform the color setting, and the extension application 204 can extend the function such that the color setting can be executed, this is not limitative. For example, in a case where the general-purpose scan software 202 can execute part of the color setting, the extension application 204 can further extend the execution range by compensating for the shortage of the color setting.

The configuration in the case where the extension application 204 is associated with the general-purpose scan software 202 and the scanning device 102 will be described with reference to FIG. 2B. As shown in FIG. 2B, differently from FIG. 2A, the extension application 204 is added. That is, the host computer 101 includes the scan application 201, the general-purpose scan software 202, and the scan function information 203, and further has the extension application 204. The extension application 204 is software for extending the function of the general-purpose scan software 202 and is sometimes simply referred to as the scan software. Note that the extension application 204 is software which is not included (packaged) in the OS in advance. Therefore, the extension application 204 is downloaded from a server (not shown) via the Internet and installed into the host computer 101 according to a user's operation of the host computer 101. Alternatively, when the scanning device 102 is connected to the host computer 101, the extension application 204 can be automatically installed into the host computer 101 according to this connection. Specifically, in a case where the scanning device 102 is connected to the host computer 101, the OS acquires device identification information from the scanning device 102. The OS can download the extension application 204 associated with this device identification information from the server via the Internet and install the downloaded extension application 204. As a result, in the host computer 101, the general-purpose scan software 202 and the extension application 204 are held as control programs independent from each other. Note that the general-purpose scan software 202 and the extension application 204 are sometimes updated and their versions are upgraded, respectively. The processing for updating the general-purpose scan software 202 and the processing for updating the extension application 204 in this case are performed at the same timing or at different timings. Further, a trigger with which the general-purpose scan software 202 is acquired by the host computer 101 and a trigger with which the extension application 204 is acquired by the host computer 101 are the same trigger or the different triggers. Further, in a case where the extension application 204 has been installed, the OS associates the extension application 204 with the general-purpose scan software 202 and the scanning device 102.

As shown in FIG. 2B, the extension application 204 is capable of exchanging information (transmission and reception of information) with the general-purpose scan software 202 and the scanning device 102, respectively. That is, the extension application 204 is associated with the general-purpose scan software 202 and the scanning device 102. In the present embodiment, the extension application 204 includes a scan setting screen-extending unit 205, a scan function-extending unit 206, an image data-editing unit 207, and a notification unit 209. Further, the extension application 204 includes shared information 208 which can be accessed from each of the scan setting screen-extending unit 205, the scan function-extending unit 206, the image data-editing unit 207, and the notification unit 209. The shared information 208 is a file stored in the external storage device 114 or information stored in the RAM 113. The extension application 204 can write and read the shared information 208 by using an application program interface (API) provided by the OS.

Note that the extension application 204 can terminate the operation as a whole of the extension application 204 in accordance with termination of processing executed by each unit of the scan setting screen-extending unit 205 to the notification unit 209. In this case, the OS starts the extension application 204 whenever a request for causing each unit to execute processing is received. Further, while the processing is being performed by each unit from the scan setting screen-extending unit 205 to the notification unit 209, the extension application 204 can cancel this processing. In this case, a job being processed on a print queue is deleted by the OS. As described above, upon receipt of a print request from a user, the scan application 201 issues a scan instruction to the OS. Further, the scan application 201 can display the scan setting screen. In the configuration shown in FIG. 2B, the scan application 201 can display the scan setting screen 300A (detailed setting screen 300C) provided by the scan setting screen-extending unit 205 (the extension application 204). Further, the scan setting screen-extending unit 205 can store detailed settings made by the user in the shared information 208.

The image data-editing unit 207 acquires image data from the scanning device 102. Then, after acquisition of the image data, the image data-editing unit 207 can also edit the acquired image data. Further, the image data-editing unit 207 acquires detailed setting information from the shared information 208 and performs image editing on the image data according to the detailed setting information. The extension application 204 can perform image editing on image data acquired by the general-purpose scan software 202 according to the detailed setting information. Further, also in the case of the configuration shown in FIG. 2B, there is a case where the color setting is not executed. In this case, the general-purpose scan software 202 can transmit a scan request instruction to the scanning device 102 without using the extension application 204.

The scan function-extending unit 206 can edit the scan function information 203 generated by the general-purpose scan software 202 or the OS. This makes it possible to add a function provided by the extension application 204. Further, it is also possible to add a function which can be executed in the scanning device 102 but cannot be executed by the general-purpose scan software 202 (such as the color setting function) and add an exclusive relationship between settings of the scan function. The OS starts the scan function-extending unit 206 when the extension application 204 is associated with the scanning device 102 and the general-purpose scan software 202 for the first time. Further, the OS can start the scan function-extending unit 206 at a timing other than this (such as a timing when the OS is started). By starting the scan function-extending unit 206 as described above, the scan function-extending unit 206 can detect the extended function and add the detected function to the scan function information 203, even in a case where a function related to scanning is extended later.

The notification unit 209 can provide, when an error of the scanning device 102 occurs, a notification indicating this fact. For example, if a reading jam error has occurred in the scanning device 102, the general-purpose scan software 202 detects occurrence of this error. The OS displays a message showing occurrence of the reading jam error as a result of the detection performed by the general-purpose scan software 202 on the display section 119 by using a notification function referred to as the toast notification which is one of the functions of the OS. Note that when the user operates the toast notification, the notification unit 209 is called by the OS, and a user interface screen (UI screen) of the notification unit 209 is displayed. On the user interface screen, for example, a detailed message concerning the reading jam error, a jam resolving method, and so forth can be displayed.

As described above, in the present embodiment, it can be said that the extension application 204 has the following four functions: The first function is the function of displaying a setting screen. This function is executed by the scan setting screen-extending unit 205. The second function is the function of editing image data according to the detailed setting information. This function is executed by the image data-editing unit 207. The third function is the function of extending a function which can be designated by using image data generation software. This function is executed by the scan function-extending unit 206. The fourth function is the function of displaying a screen in response to occurrence of an error in the scanning device 102. This function is executed by the notification unit 209. Note that the configuration of the extension application 204 is not limited to the configuration having these four functions but is preferable to have at least one function of them, and further, the extension application 204 can be configured to further have another function.

FIGS. 3A to 3C are diagrams each showing an example of a screen displayed on the display section of the scan system. FIG. 3A shows the scan setting screen displayed by the scan application 201. FIG. 3B shows the detailed setting screen displayed in the case of the configuration in which the extension application 204 is not associated. FIG. 3C shows the detailed setting screen displayed in the case of the configuration in which the extension application 204 is associated. Note that a unit or module that displays each screen is not particularly limited. For example, the scan setting screen-extending unit 205 is only required to be configured to be capable of generating a display screen. In this case, the scan setting screen-extending unit 205 transmits the generated display screen to the scan application 201 via the general-purpose scan software 202. The scan application 201 can be configured to display the acquired display screen.

The scan setting screen 300A shown in FIG. 3A is a screen on which the color setting associated with scanning performed by the scanning device 102 can be set. This scan setting screen 300A includes a control (button) 301, a control 302, a control 303, and a control 304. With the control 301, the user can select and set a scanner device used for reading an original. In the illustrated example in FIG. 3A, the scanner device used for reading an original is set to “scanner 001 (common driver)” by way of example. With the control 302, the user can set details of the color setting. With the control 303, the user can instruct the scanning device 102 to start scanning. With the control 304, the user can instruct the scanning device 102 to cancel scanning.

When the control 302 is operated in the case of the configuration in which the extension application 204 is not associated, the detailed setting screen 300B shown in FIG. 3B is displayed. The detailed setting screen 300B includes a control 305 and a control 306. With the control 305, the user can select and set a scanning location of an original in the scanning device 102, i.e. a placement section where an original to be read is placed. For example, in a case where the scanning device 102 has an original platen glass and a feeder as the original scanning location, in FIG. 3B, the original platen glass is selected by way of example. With the control 306, the user can terminate the setting set on the detailed setting screen 300B. Further, when the control 306 is operated, the screen returns to the scan setting screen 300A shown in FIG. 3A.

When the control 302 is operated in the case of the configuration in which the extension application 204 is associated, the detailed setting screen (setting reception screen) 300C shown in FIG. 3C is displayed. Note that the detailed setting screen 300C is a screen displayed together with the scan setting screen 300A, but its display form is not particularly limited. For example, the detailed setting screen 300C is only required to be displayed in a state overlapping the scan setting screen 300A. Further, the detailed setting screen 300C can be displayed adjacent to the scan setting screen 300A or cab be displayed after the scan setting screen 300A once disappears. Similar to the detailed setting screen 300B, the detailed setting screen 300C includes the control 305 and the control 306. Further, the detailed setting screen 300C additionally includes a control 307. With the control 307, the user can select a type of the color setting set in the scanning device 102. When the control 307 is operated, a list 308 is displayed. The list 308 includes “full color”, “gray scale”, and “monochrome binary” as the color setting (color mode), and in the illustrated example in FIG. 3C, “full color” is selected by way of example. When “full color” is selected, a read image read by the scanning device 102 is expressed in full color. Further, when “gray scale” is selected, a read image is expressed in gray scale. Further, when “monochrome binary” is selected, a read image read by the scanning device 102 is expressed in monochrome. Then, by operating the control 306, termination of the setting in the control 307, i.e. termination of the color setting can be determined. Thus, on the detailed setting screen 300C, the control 306 functions as a determination operation section for determining termination of the color setting. In a case where termination of the color setting is determined, it is possible to output a scan instruction for causing the scanning device 102 to scan an original under the conditions of this color setting.

Here, a reason why the items included in the detailed setting screen 300B and the items included in the detailed setting screen 300C are different will be described. That is, a reason why it is possible to switch whether to display the detailed setting screen 300B or the detailed setting screen 300C will be described. The detailed setting screen 300B and the detailed setting screen 300C are generated based on respective pieces of the scan function information (capabilities information). As mentioned above, the general-purpose scan software 202 does not support the color setting. Therefore, the color setting function cannot be added to the scan function information only by the general-purpose scan software 202. Further, even if the color setting function is originally included in the scan function information, the general-purpose scan software 202 cannot interpret the color setting function included in the scan function information. For this reason, the color setting cannot be displayed on the detailed setting screen. To cope with this, the scan function-extending unit 206 adds the color setting function to the scan function information 203. Then, the scan setting screen-extending unit 205 displays the detailed setting screen 300C by referring to the capabilities information. This detailed setting screen 300C is a screen on which the color setting can be made. Note that the detailed setting screen 300C can additionally include a setting item other than the color setting.

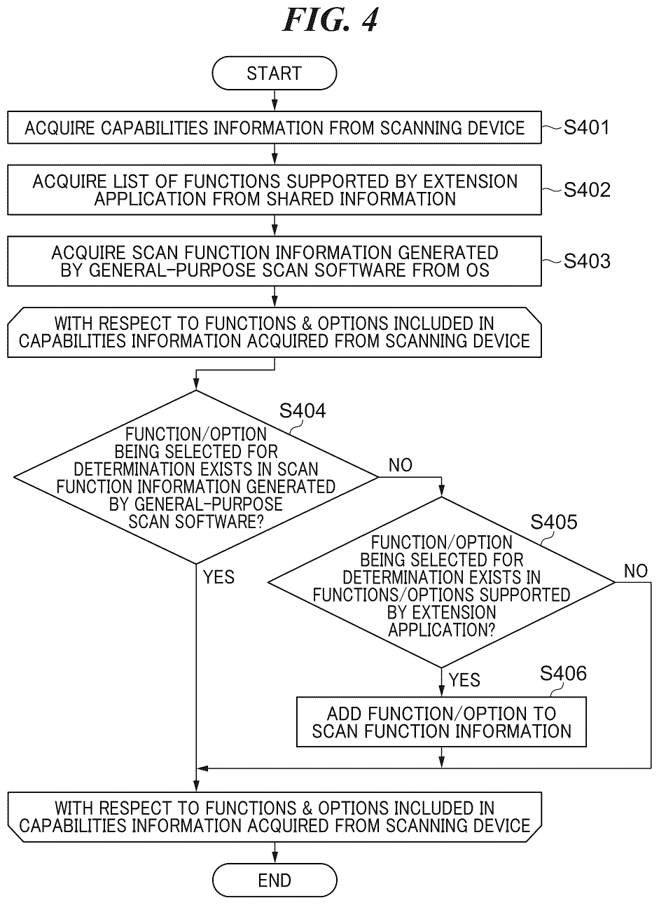

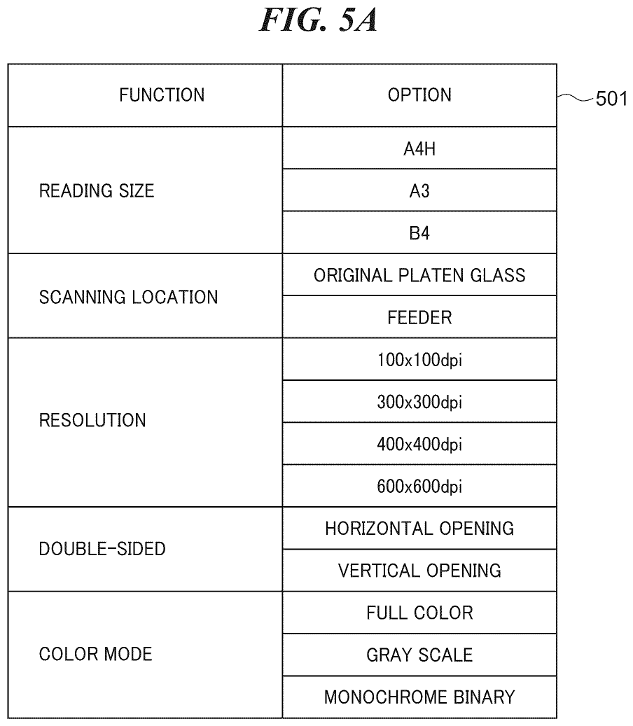

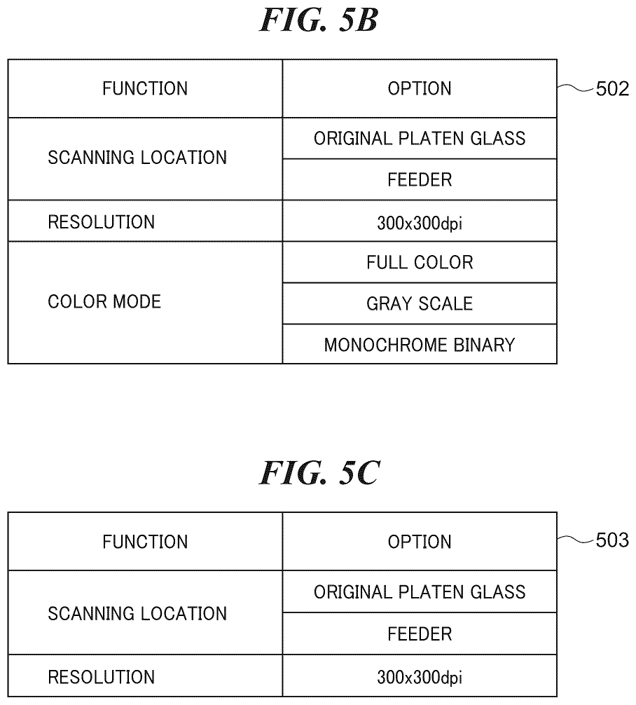

FIG. 4 is a flowchart of a process performed by the scan function-extending unit 206, for editing the scan function information. Note that the process in FIG. 4 is executed by the scan function-extending unit 206 under the control of the CPU 111. FIGS. 5A to 5C are diagrams each showing an example of a list of the scan information. As shown in FIG. 4, in a step S401, the scan function-extending unit 206 acquires the capabilities information from the scanning device 102. The capabilities information is attribute information indicating the functions which can be designated in the scanning device 102 and settings associated with this attribute information. A table 501 shown in FIG. 5A indicates a list of the capabilities information acquired from the scanning device 102. As shown in the table 501, the functions, such as the color mode setting, and options which can be set to each function, can be acquired from the scanning device 102. For example, the function of the color mode setting has options of “full color, “gray scale”, and “monochrome binary”.

In a step S402, the scan function-extending unit 206 acquires scan functions supported by the extension application 204 from the shared information 208. In the shared information 208, a list of the scan functions supported by the extension application 204 is stored. A table 502 shown in FIG. 5B includes all scan functions which can be executed (supported) by the extension application 204 and the settings of these scan functions. For example, the function of the color mode setting has options of “full color, “gray scale”, and “monochrome binary”. Further, the scan functions which can be executed by the extension application 204 are sometimes updated e.g. by the update of the extension application 204.

In a step S403, the scan function-extending unit 206 acquires the scan function information 203 generated by the general-purpose scan software 202 from the OS. The scan function information 203 is generated by the general-purpose scan software 202 based on the capabilities information acquired from the scanning device 102. The scan function information 203 generated by the general-purpose scan software 202 includes only the scan functions which can be executed by the general-purpose scan software 202, out of the capabilities information acquired from the scanning device 102. A table 503 shown in FIG. 5C includes all scan functions which can be executed by the general-purpose scan software 202 and the settings of these scan functions. As shown in the table 503, the scan functions which can be executed by the general-purpose scan software 202 does not include the function of the color mode setting. Therefore, the color mode setting is not included in the scan function information 203. By adding a function and options thereof to the scan function information 203 by using the scan function-extending unit 206, the extension application 204 can compensate for lack of the functions of the general-purpose scan software 202. Further, the scan function-extending unit 206 is also capable of deleting an unnecessary function and options thereof from the scan function information 203 generated by the general-purpose scan software 202.

A step S404, a step S405, and a step S406 are processing operations which are repeatedly executed on the list of the functions included in the capabilities information acquired from the scanning device 102 in the step S401. In the present embodiment, the steps S404, S405, and S406 are repeatedly executed on all of the 14 options included in the table 501.

In the step S404, the scan function-extending unit 206 determines whether or not a function and its option, being currently selected for determination, exist in the scan function information 203 generated by the general-purpose scan software 202. If it is determined in the step S404 that the function and its option, being currently selected for determination, exist in the scan function information 203, the present process is terminated if the option being selected for determination is the final item of the options of the function. Alternatively, if the option being selected for determination is not the final item of the options of the function, the next item of the options is selected, and the step S404 is executed again. On the other hand, if it is determined in the step S404 that the function and its option, being currently selected for determination, do not exist in the scan function information 203, the process proceeds to the step S405. For example, in the present embodiment, the scanning location “original platen glass” is included in the table 501, and the scanning location “original platen glass” is also included in the table 503. In this case, it is determined in the step S404 that the function and its option, being currently selected for determination, exist in the scan function information 203. On the other hand, “full color” is included in the table 501 but is not included in the table 503. In this case, it is determined in the step S404 that the function and its option, being currently selected for determination, do not exist in the scan function information 203.

In the step S405, the scan function-extending unit 206 determines whether or not the function and its option, being currently selected for determination, exist in the functions and their options supported by the extension application 204. If it is determined in the step S405 that the function and its option being currently selected for determination exist, the process proceeds to the step S406. On the other hand, if it is determined in the step S405 that the function and its option being currently selected for determination do not exist, similar to the case where the answer to the question of the step S404 is affirmative (YES), the present process is terminated if the option being selected for determination is the final item of the options of the function. Alternatively, if the option being selected for determination is not the final item of the options of the function, the next item of the options is selected, and the step S404 is executed again. For example, in the present embodiment, in a case where the option of the function being currently selected for determination is “full color”, the option “full color” also exists in the table 502. Therefore, it is determined in the step S405 that the option of the function being currently selected for determination exist.

In the step S406, the scan function-extending unit 206 adds the function and its option being currently selected for determination to the scan function information 203. After execution of the step S406, similar to the case where the answer to the question of the step S404 is affirmative (YES), the present process is terminated if the option being selected for determination is the final item of the options of the function. Alternatively, if the option being selected for determination is not the final item of the options of the function, the next item of the options is selected, and the step S404 is executed again.

As described above, the extension application 204 can add, to the scan function information 203, a function and its option which are not supported by the general-purpose scan software 202 but are supported by the scanning device 102, and at the same time can be supported by the extension application 204. Then, the capabilities information is generated based on the scan function information 203 edited by this addition processing. Further, by generating a display screen based on the resulting capabilities information, the scan setting screen-extending unit 205 can extend the function not supported or not fully supported by the general-purpose scan software 202 and display the detailed setting screen 300C shown in FIG. 3C.

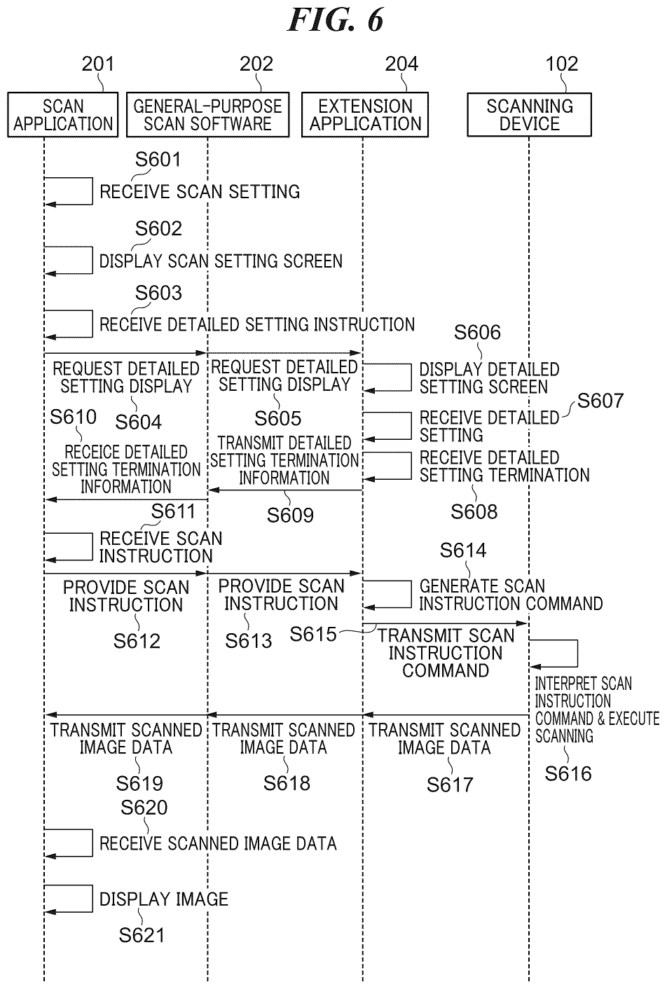

FIG. 6 is a sequence diagram showing a process executed between the scan application 201, the general-purpose scan software 202, the extension application 204, and the scanning device 102 after the scan application 201 receives a scan setting instruction. Processing operations performed by the scan application 201, the general-purpose scan software 202, and the extension application 204 are executed by the CPU 111 of the host computer 101. A processing program for the operations is stored in the external storage device 114. The CPU 111 loads the processing program from the external storage device 114 into the RAM 113 and executes the loaded processing program. Further, processing operations performed by the scanning device 102 are executed by the CPU 191 of the scanning device 102. A processing program for the operations is stored in the external storage device 199. The CPU 191 loads the processing program from the external storage device 199 into the RAM 193 and executes the loaded processing program. Further, the software configuration of the scan system 1000 is shown in FIG. 2B.

Referring to FIG. 6, in a step S601, the scan application 201 receives the scan setting by a user. The user can instruct the scan setting to the scan application 201 by operating e.g. the pointing device 117 and the keyboard 118.

In a step S602, the scan application 201 displays the scan setting screen 300A shown in FIG. 3A on the display section 119.

In a step S603, the scan application 201 receives a detailed setting instruction provided by the user. The user can instruct the detailed setting by operating e.g. the pointing device 117 and the keyboard 118 to select the control 302 on the scan setting screen 300A.

In a step S604, the scan application 201 requests the general-purpose scan software 202 to display the detailed setting.

In a step S605, the general-purpose scan software 202 requests the extension application 204 to display the detailed setting.

In a step S606, the scan setting screen-extending unit 205 of the extension application 204 displays the detailed setting screen 300C shown in FIG. 3C on the display section 119 in response to the request received in the step S605. As described hereinabove, the color mode setting (color setting) function is added to the scan function information 203 by the scan function-extending unit 206. The scan setting screen-extending unit 205 can display the detailed setting screen 300C by referring to the capabilities information generated based on the scan function information 203 to which the color mode setting function has been added. Note that in a case where a setting item of resolution of an image and the like are included, these setting items can be displayed as required, or can be inhibited from being displayed or be displayed in a grayed-out state.

In a step S607, the scan setting screen-extending unit 205 receives the detailed setting input by the user on the detailed setting screen 300C. Note that, here, on the detailed setting screen 300C, the scanning location “the original platen glass” is selected by the control 305, and the color mode “full color” is selected by the control 307 by way of example (see FIG. 3C). In this setting state, the scan setting screen-extending unit 205 receives the operation of the control 306 on the detailed setting screen 300C, performed by the user. With this, the CPU 111 stores the setting state on the detailed setting screen 300C in the RAM 113.

In a step S608, the scan setting screen-extending unit 205 receives termination of the detailed setting performed by the user based on the operation of the control 306 in the step S607. The user can instruct termination of the detailed setting by operating e.g. the pointing device 117 and the keyboard 118 to select the control 306. With this, the setting state on the detailed setting screen 300C is written into the scan function information 203. Note that the information written into the scan function information 203 can also include, for example, the information inhibited from being displayed or displayed in the grayed-out state.

In a step S609, the extension application 204 transmits detailed setting termination information to the effect that the detailed setting in the S608 has been terminated, to the general-purpose scan software 202.

In a step S610, the general-purpose scan software 202 receives the detailed setting termination information sent from the extension application 204 in the step S609. Then, the general-purpose scan software 202 transmits this detailed setting termination information to the scan application 201.

In a step S611, the scan application 201 receives a scan instruction provided by the user. The user can instruct scanning by operating e.g. the pointing device 117 and the keyboard 118 to select the control 303 on the scan setting screen 300A (see FIG. 3A).

In a step S612, the scan application 201 provides the scan instruction received in the step S611 to the general-purpose scan software 202.

In a step S613, the general-purpose scan software 202 receives the scan instruction provided in the step S612. Then, the general-purpose scan software 202 provides this scan instruction to the extension application 204.

In a step S614, the extension application 204 receives the scan instruction provided in the step S613. Then, the extension application 204 generates a scan instruction command based on the scan function information 203 in which the setting state on the detailed setting screen 300C has been written in the step S608. Note that this scan instruction command includes the setting information of the color mode (color mode “full color”) received on the detailed setting screen 300C. Further, there is a case where the information inhibited from being displayed or displayed in the grayed-out state in the step S608 has not been written into the scan function information 203. In this case, in the step S614, the extension application 204 can add the information which has not been written into the scan function information 203 to the scan instruction command or set the default value.

In a step 615, the extension application 204 transmits the scan instruction command generated in the step S614 to the scanning device 102.

In a step S616, the input/output interface 198 of the scanning device 102 receives the scan instruction command transmitted in the step S615. Then, the reading section 195 of the scanning device 102 interprets the scan instruction command and executes scanning under the conditions set on the detailed setting screen 300C. As a result, full-color image data is obtained as the scanned image data (read image data). The image processor 190 of the scanning device 102 can execute necessary image processing according to the scan instruction on the scanned image data.

In a step S617, the input/output interface 198 of the scanning device 102 transmits the scanned image data obtained in the step S616 to the extension application 204.

In a step 618, the extension application 204 receives the scanned image data transmitted in the step S617. Then, the extension application 204 transmits this scanned image data to the general-purpose scan software 202.

In a step S619, the general-purpose scan software 202 receives the scanned image data sent in the step S618. Then, the general-purpose scan software 202 transmits this scanned image data to the scan application 201.

In a step S620, the scan application 201 receives the scanned image data sent in the step S619.

In a step S621, the scan application 201 displays the scanned image data received in the step S620 on the display section 119. As a result, the scanned image data, i.e. a result of reading the original in the step S616 is displayed on the display section 119 as a preview image.

As described above, in the scan system 1000, even in a case where the general-purpose scan software 202 does not support the color mode setting (scan condition setting), it is possible to execute the color mode setting by using the extension application 204. This enables the scanning device 102 to perform scanning under the color mode setting. Note that in the description given with reference to FIG. 6, the detailed setting screen 300C shown in FIG. 3C is displayed by assuming that the software configuration of the scan system 1000 is as shown in FIG. 2B, but this is not limitative. For example, in a case where a request for displaying the detailed setting is provided to the general-purpose scan software 202, the general-purpose scan software 202 displays the detailed setting screen 300B shown in FIG. 3B. In this case, after the control 306 on the detailed setting screen 300B is operated, the general-purpose scan software 202 requests the extension application 204 to display an additional detailed setting screen. Then, the extension application 204 can additionally display a detailed setting screen on which the color mode setting can be made.

Further, in the step S613, the scan instruction is provided from the general-purpose scan software 202 to the extension application 204, but this is not limitative. For example, the scan instruction can be provided from the scan application 201 to the extension application 204. Further, a control for a scan instruction can be disposed on the detailed setting screen 300C. In this case, when the user operates the control for a scan instruction, a scan instruction is provided to the extension application 204. Further, the scanned image data can be transmitted from the scanning device 102 to the scan application 201 via the extension application 204 without via the general-purpose scan software 202. Further, the scanned image data can be transmitted from the scanning device 102 directly to the scan application 201. Further, the scan system 1000 can be configured such that the scanned image data is stored in the external storage device 114, and only information of a file path as storage destination can be sent and received. Further, in the scan system 1000, in a case where there are a plurality of scanned image data items, all of the scanned image data items can be collectively transmitted, or each scanned image data item can be transmitted whenever the scanned image data item is obtained.

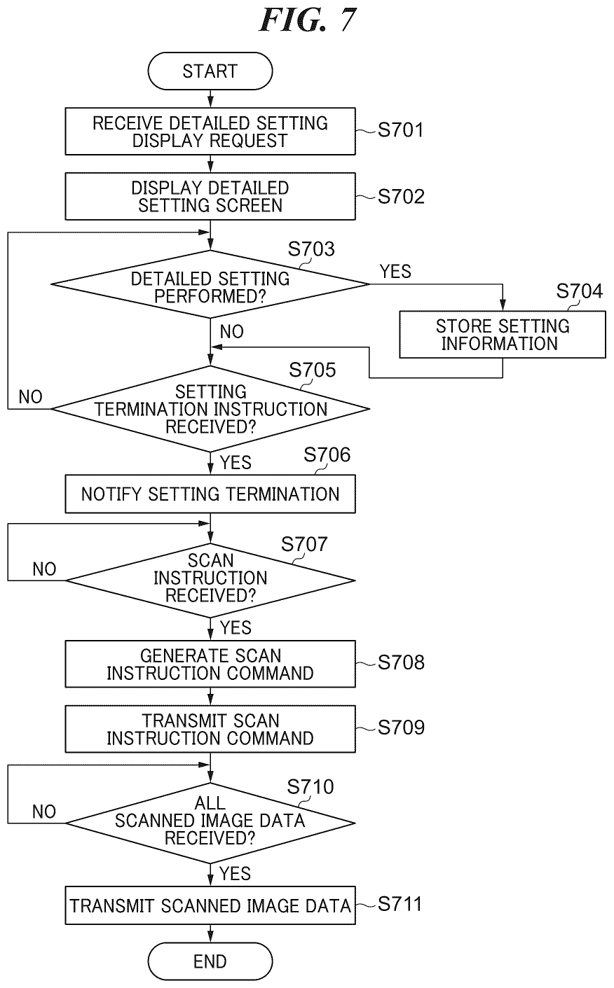

FIG. 7 is a flowchart of the process performed by the extension application. A program for executing the process in FIG. 7 is stored in the external storage device 114. The CPU 111 can execute the present process by loading the program from the external storage device 114 into the RAM 113. Referring to FIG. 7, in a step S701, the extension application 204 receives the request for displaying the detailed setting (see the step S605) from the general-purpose scan software 202.

In a step S702, the scan setting screen-extending unit 205 of the extension application 204 displays the detailed setting screen 300C shown in FIG. 3C on the display section 119 in response to the detailed setting display request received in the step S701. As described hereinabove, the function of setting the color mode is added to the scan function information 203. The scan setting screen-extending unit 205 can display the detailed setting screen 300C by referring to the capabilities information generated based on the scan function information 203.

In a step S703, the scan setting screen-extending unit 205 determines whether or not the detailed setting has been performed on the detailed setting screen 300C, i.e. whether or not a selection operation has been performed on the control 305 or the control 307. If it is determined in the step S703 that the detailed setting has been performed, the process proceeds to a step S704. On the other hand, if it is determined in the step S703 that the detailed setting has not been performed, the process proceeds to a step S705.

In the step S704, the scan setting screen-extending unit 205 stores (saves) the setting state (setting information) on the detailed setting screen 300C in the RAM 113.

In the step S705, the scan setting screen-extending unit 205 determines whether or not a detailed setting termination instruction has been provided on the detailed setting screen 300C, i.e. whether or not control 306 has been operated. If it is determined in the step S705 that a detailed setting termination instruction has been provided, the process proceeds to a step S706. On the other hand, if it is determined in the step S705 that a detailed setting termination instruction has not been provided, the process returns to the step S703 to sequentially execute the step S703 et seq.

In the step S706, the extension application 204 notifies the general-purpose scan software 202 of the detailed setting termination instruction provided in the step S705.

In a step S707, the extension application 204 determines whether or not a scan instruction has been provided from the general-purpose scan software 202 (see the step S613). If it is determined in the step S707 that a scan instruction has been provided, the process proceeds to a step S708. On the other hand, if it is determined in the step S707 that a scan instruction has not been provided, the process remains in the step S707.

In the step S708, the extension application 204 generates a scan instruction command based on the scan function information 203 in which the setting state on the detailed setting screen 300C has been written. Further, as the method of generating a scan instruction command, for example, a method of extending a standard protocol command can be used. Further, as this extension method, for example, a method of describing a dedicated command in an extended area of the standard protocol command can be used. The other extension methods include a method of adding an original standard command to the end of the standard protocol command, a method of the extension application 204 overwriting the standard protocol command with an original command system, and so forth. Further, in a case where an instruction is provided from the extension application 204, instruction and communication can be performed according to a protocol unique to a maker regardless of the standard protocol.

In a step S709, the extension application 204 transmits the scan instruction command generated in the step S708 to the scanning device 102.

In a step S710, the extension application 204 determines whether or not all of the scanned image data items (see the step S617) from the scanning device 102 have been received. If it is determined in the step S710 that all of the scanned image data items have been received, the process proceeds to a step S711. On the other hand, if it is determined in the step S710 that all of the scanned image data items have not been received, the process remains in the step S710.

In the step S711, the extension application 204 transmits all the scanned image data received from the scanning device 102 to the general-purpose scan software 202, followed by terminating the present process.

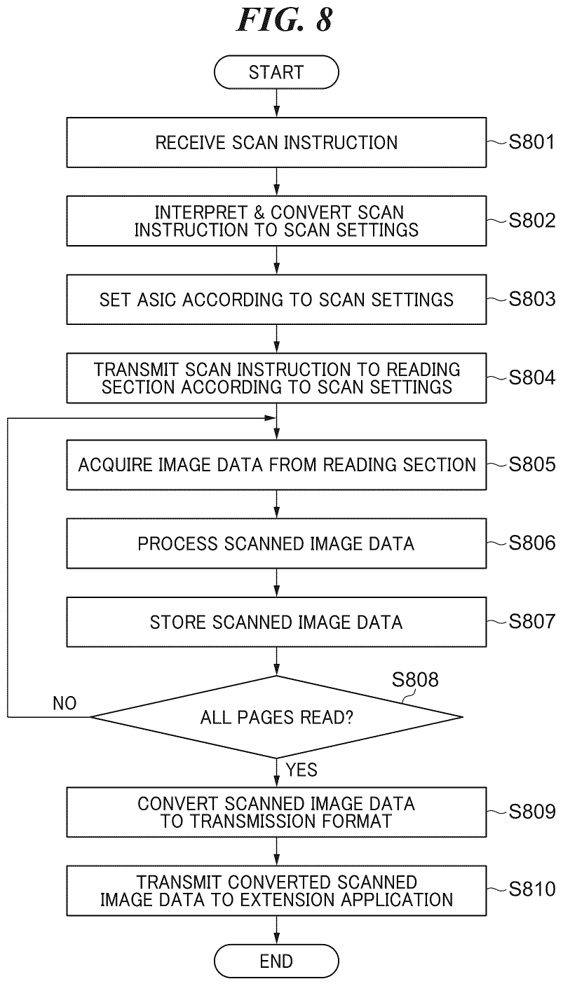

FIG. 8 is a flowchart of the process performed by the scanning device 102. A program for executing the process in FIG. 8 is stored in the external storage device 199. The CPU 191 can execute the present process by loading the program from the external storage device 199 into the RAM 192. Referring to FIG. 8, in a step S801, the CPU 191 receives the scan instruction command (see the step S615) from the extension application 204.

In a step S802, the CPU 191 interprets the scan instruction command received in the step S801. Then, the CPU 191 converts the scan instruction command to scan settings for enabling the scanning device 102 to execute scan processing, i.e. settings for enabling execution of scanning under the conditions (color mode “full color”) set on the detailed setting screen 300C.

In a step S803, the CPU 191 determines an application specific integrated circuit (ASIC) of the image processor 190, which is to be used to execute scanning according to the settings (scan settings) obtained in the step S802 and perform setting of the ASIC.

In a step S804, the CPU 191 transmits a reading instruction based on the scan settings to the reading section 195.

In a step S805, the CPU 191 acquires scanned image data from the reading section 195. The scanned image data is full-color image data.

In a step S806, the CPU 191 controls the image processor 190 to execute image processing on the scanned image data acquired in the step S805. As the image processing, in the present embodiment, processing for converting the resolution to 300×300 dpi is performed, for example. Note that in a case where the reading section 195 is capable of performing reading at the resolution of 300×300 dpi, the scanned image data can be acquired at the resolution of 300×300 dpi by the reading section 195. In this case, the step S806 can be omitted.

In a step S807, the CPU 191 saves the scanned image data in the external storage device 199.

In a step S808, the CPU 191 determines whether or not the scan processing has been completed with respect to all of the pages of the original to be read, i.e. scanned. If it is determined in the step S808 that the scan processing has been completed, the process proceeds to a step S809. On the other hand, if it is determined in the step S808 that the scan processing has not been completed, the process returns to the step S805, to sequentially execute the step S805 et seq.

In the step S809, the CPU 191 controls the image processor 190 to convert the scanned image data saved in the step S807 to a transmission format. In the present embodiment, the transmission format is not included in the scan instruction command received in the step S801. Therefore, the scanned image data is converted to JPEG as the default setting of the scanning device 102, but this is not limitative.

In a step S810, the CPU 191 controls the input/output interface 198 to transmit the scanned image data converted in the step S809 to the extension application 204, followed by terminating the present process.

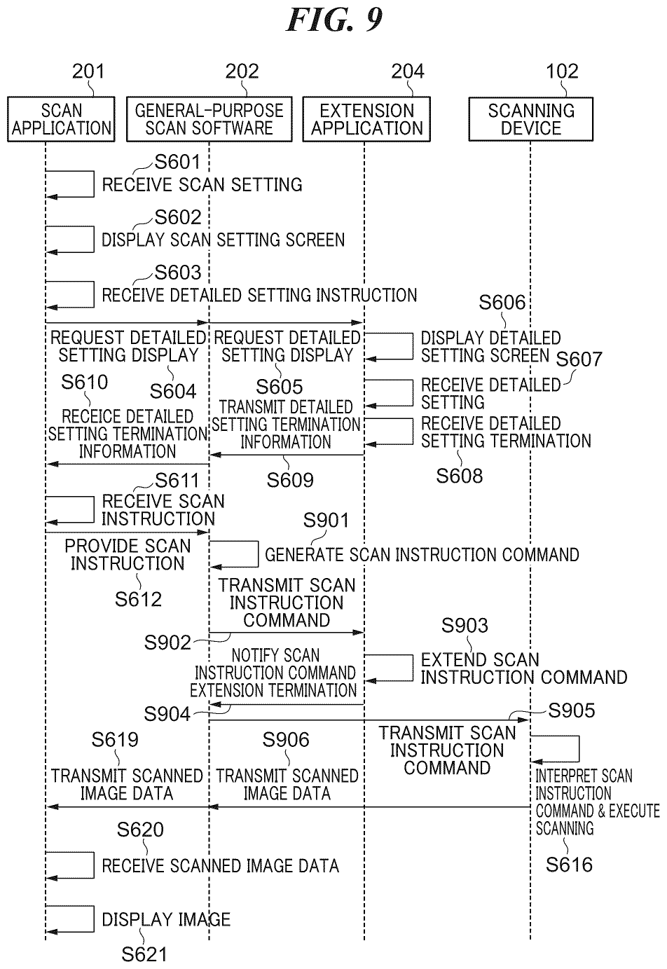

Next, a second embodiment will be described below with reference to FIG. 9, but the description will be given mainly of different points from the above-described embodiment, and description of the same points is omitted.

FIG. 9 is a sequence diagram showing a process executed between the scan application 201, the general-purpose scan software 202, the extension application 204, and the scanning device 102, after the scan application receives a scan setting instruction in the second embodiment. In the sequence diagram shown in FIG. 9, differently from the sequence diagram shown in FIG. 6, after execution of the step S612, steps S901 to S905 are sequentially executed in place of the steps S613 to S615. Further, after execution of the step S616, a step S906 is executed in place of the steps S617 and S618. As shown in FIG. 9, in the step S901, the general-purpose scan software 202 receives the scan instruction provided in the step S612. Then, the general-purpose scan software 202 generates a scan instruction command based on the scan function information 203 in which the setting state on the detailed setting screen 300C has been written in the step S608. Note that this scan instruction command does not include a function which is not supported by the general-purpose scan software 202.

In the step S902, the general-purpose scan software 202 transmits the scan instruction command generated in the step S901 to the extension application 204.

In the step S903, the extension application 204 receives the scan instruction command sent in the step S902. Then, the extension application 204 adds an instruction command of a function which is not supported by the general-purpose scan software 202 and changes the existing instruction for the scan instruction command. With this, the function of the scan instruction command is extended. Specifically, since the color mode setting is not included in the scan instruction command generated by the general-purpose scan software 202 in the step S901, the color mode setting is added in the step S903.

In the step S904, the extension application 204 notifies the general-purpose scan software 202 that extension of the function of the scan instruction command in the S903 is completed. Further, the extension application 204 transmits the scan instruction command in which the function has been extended in the step S903 to the general-purpose scan software 202.

In the step S905, the general-purpose scan software 202 receives the scan instruction command sent in the step S904. Then, the general-purpose scan software 202 transmits this scan instruction command to the scanning device 102.

In the step S906, the input/output interface 198 of the scanning device 102 transmits the scanned image data obtained in the step S616 to the general-purpose scan software 202. With this, the general-purpose scan software 202 can receive this scanned image data.

As described above, in the present embodiment, it is possible to transmit the scan instruction command in which the color mode setting function has been extended by the extension application 204 to the scanning device 102 via the general-purpose scan software 202. As a result, it is possible to perform scanning under the color mode setting.

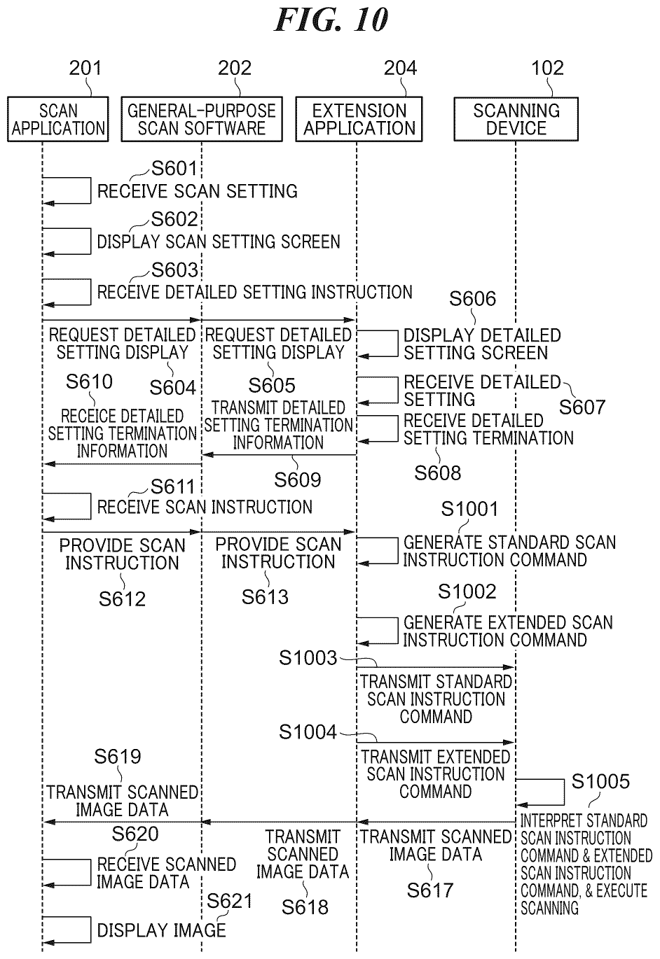

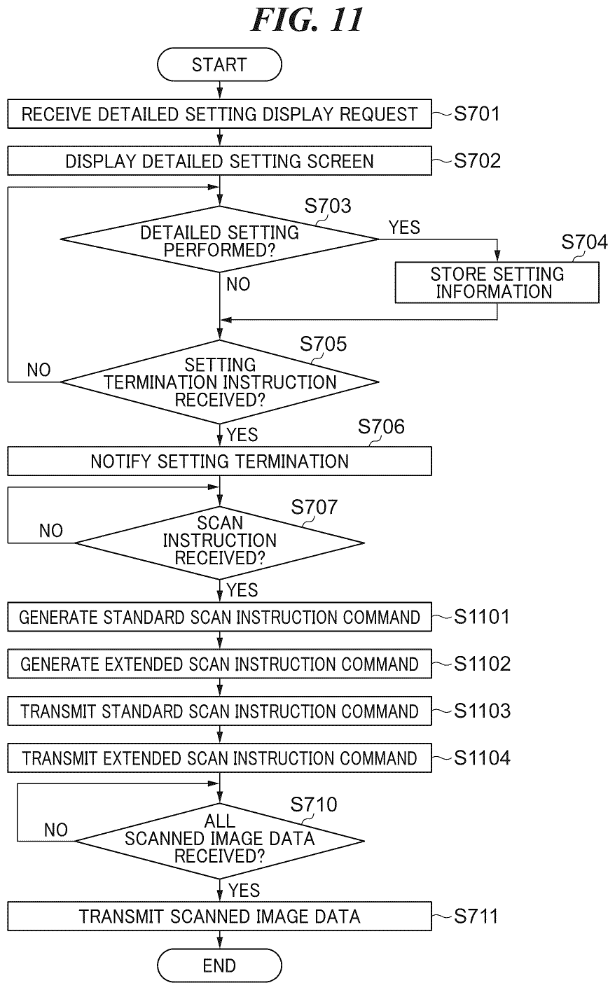

A third embodiment will be described below with reference to FIGS. 10 and 11, but the description will be given mainly of different points from the above-described embodiment, and description of the same points is omitted.

FIG. 10 is a sequence diagram showing a process executed between the scan application 201, the general-purpose scan software 202, the extension application 204, and the scanning device 102, after the scan application receives a scan setting instruction in the third embodiment. In the sequence diagram shown in FIG. 10, differently from the sequence diagram shown in FIG. 6, after execution of the step S613, steps S1001 to S1005 are sequentially executed in place of the steps S614 to S616. As shown in FIG. 10, in the step S1001, the extension application 204 receives the scan instruction provided in the step S613. Then, the extension application 204 generates a standard scan instruction command according to the standard protocol. Note that this scan instruction command does not include a function which is not supported by the standard protocol.

In the step S1002, the extension application 204 generates an extended scan instruction command with respect to the function which is supported only by the extension application 204.

In the step S1003, the extension application 204 transmits the standard scan instruction command generated in the step S1001 to the scanning device 102.

In the step S1004, the extension application 204 transmits the extended scan instruction command generated in the step S1002 to the scanning device 102.

In the step S1005, the input/output interface 198 of the scanning device 102 receives the standard scan instruction command transmitted in the step S1003 and the extended scan instruction command transmitted in the step S1004. Then, the reading section 195 of the scanning device 102 interprets the standard scan instruction command and the extended scan instruction command, respectively, and executes scanning. With this, as the scanned image data, full-color image data is obtained.

As described above, in the present embodiment, the color mode setting function is not extended with respect to the standard scan instruction command, and it is possible to cope with the color mode setting function supported only by the extension application 204 by using another scan instruction command. With this, it is possible to perform scanning under the color mode setting.

FIG. 11 is a flowchart of the process performed by the extension application. In the flowchart shown in FIG. 11, differently from the flowchart shown in FIG. 7, steps S1101 to S1104 are sequentially executed in place of the steps S708 and S709. In the step S1101, the extension application 204 generates a standard scan instruction command according to the standard protocol.

In the step S1102, the extension application 204 generates an extended scan instruction command with respect to a function which is not supported by the standard protocol but supported only by the extension application 204.

In the step S1103, the extension application 204 transmits the standard scan instruction command generated in the step S1101 to the scanning device 102.

In the step S1104, the extension application 204 transmits the extended scan instruction command generated in the step S1102 to the scanning device 102. After execution of the step S1104, the process proceeds to the step S710.

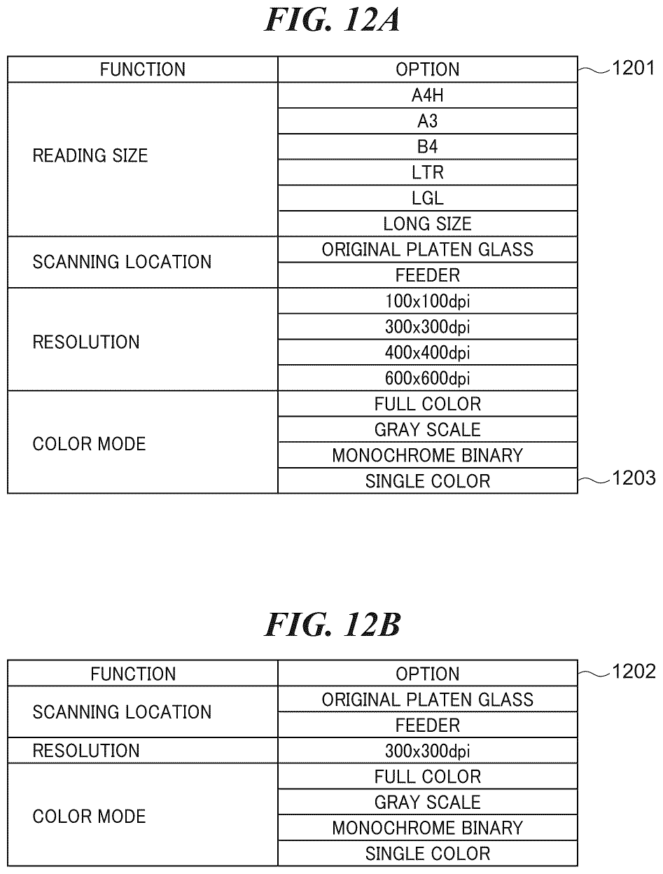

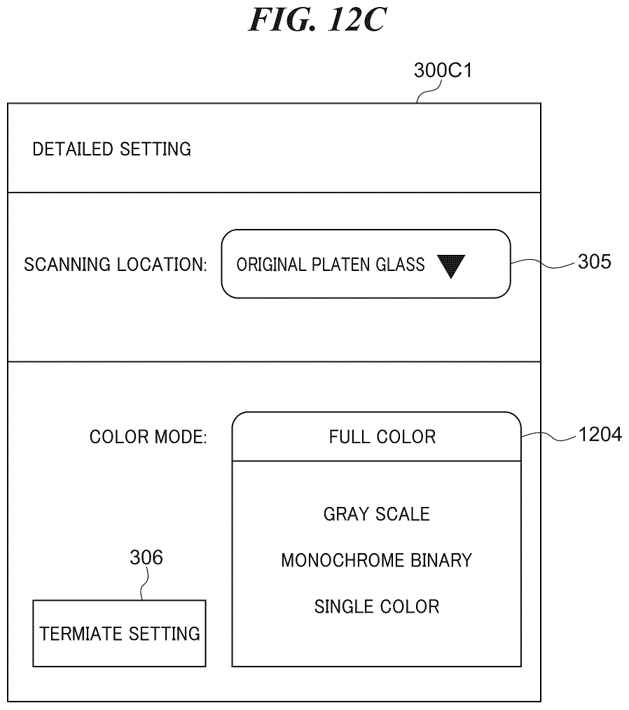

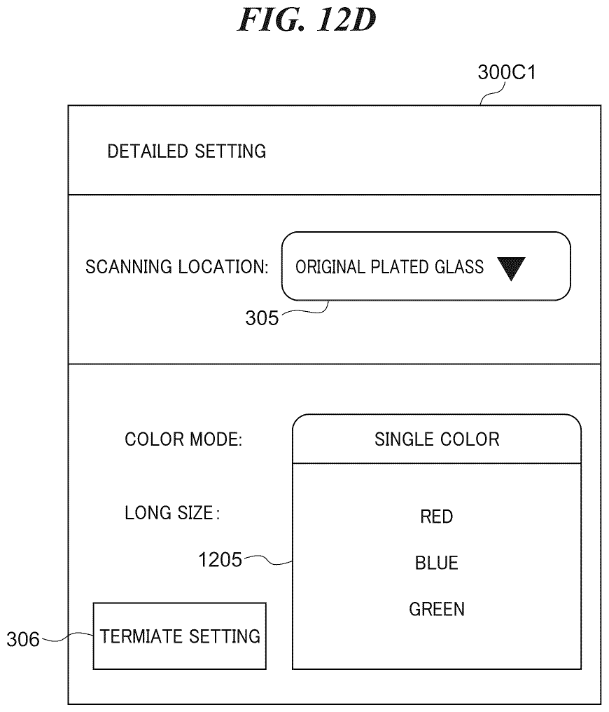

A fourth embodiment will be described below with reference to FIGS. 12A to 12D, but the description will be given mainly of different points from the above-described embodiments, and description of the same points is omitted. FIGS. 12A to 12D are diagrams associated with the scan information in the fourth embodiment. A table 1201 shown in FIG. 12A indicates an example of a list of the capabilities information acquired from the scanning device 102. As indicated in the table 1201, information 1203 can be acquired. The information 1203 is information to the effect that the color mode has an option of setting of expressing a scanned image with a desired one color (hereinafter referred to as the “single color setting”). A table 1202 shown in FIG. 12B includes all scan functions which can be executed (supported) by the extension application 204 and the settings (options) of these functions, and indicates that the single color setting is also available.

A detailed setting screen 300C1 shown in FIG. 12C is in a state in which the single color setting can be made. On the detailed setting screen 300C1, the color mode “single color” is included in a list 1204. So, in a case where “single color” in the list 1204 is selected, the detailed setting screen 300C1 shifts to a state shown in FIG. 12D. On the detailed setting screen 300C1 shown in FIG. 12D, a plurality of colors (options) which can be selected for the single color setting are included in a list 1205. The colors which can be selected for the single color setting are not particularly limited and include, for example, “red”, “blue”, and “green”. For example, in a case where “red” is selected, the scanned image is expressed in one color of red. Note that in the single color setting, a luminance value can be made selectable.

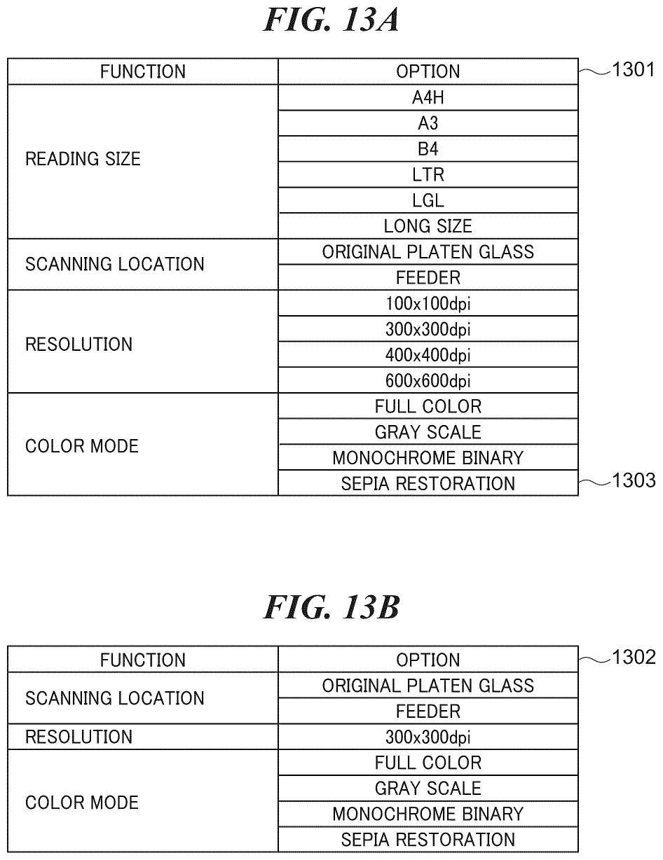

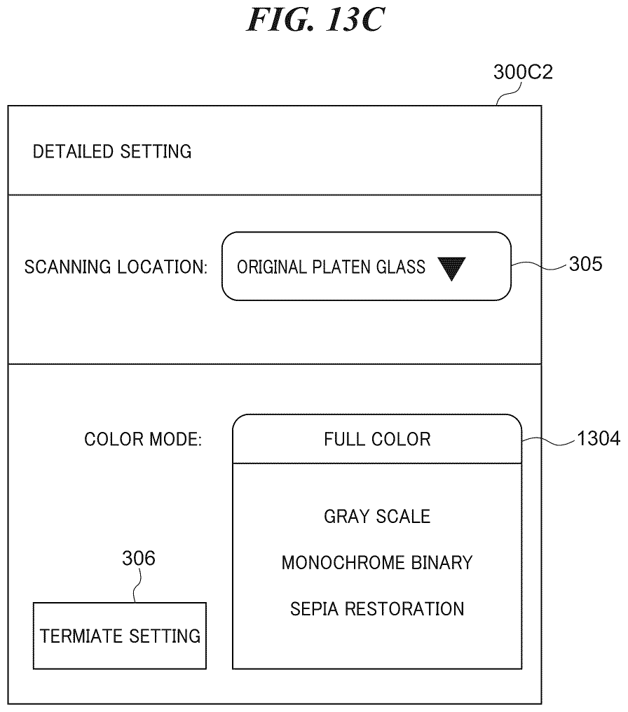

A fifth embodiment will be described below with reference to FIGS. 13A to 13C, but the description will be given mainly of different points from the above-described embodiments, and description of the same points is omitted. FIGS. 13A to 13C are diagrams associated with the scan information in the fifth embodiment. A table 1301 shown in FIG. 13A indicates an example of a list of the capabilities information acquired from the scanning device 102. As indicated in the table 1301, information 1303 can be acquired. The information 1303 is information to the effect that the color mode has an option of setting of restoring a scanned image in full color in a case where an original having a faded sepia color is scanned (hereinafter referred to as the “sepia restoration setting”). A table 1302 shown in FIG. 13B includes all scan functions which can be executed by the extension application 204 and the settings of these functions, and indicates that the sepia restoration setting can also be executed. A detailed setting screen 300C2 shown in FIG. 13C is in a state in which the sepia restoration setting can be made. On the detailed setting screen 300C2, the color mode “sepia restoration” is included in a list 1304. So, in a case where “sepia restoration” in the list 1304 is selected, the scanned image is expressed in full color. Thus, in the present embodiment, it is possible to switch the color mode to the sepia restoration setting, depending on to the original. Note that sepia restoration can be performed by storing a color mode conversion table in the external storage device 199 in advance and applying the conversion table to scanned image data. Further, sepia restoration can be performed by using e.g. a learned model.

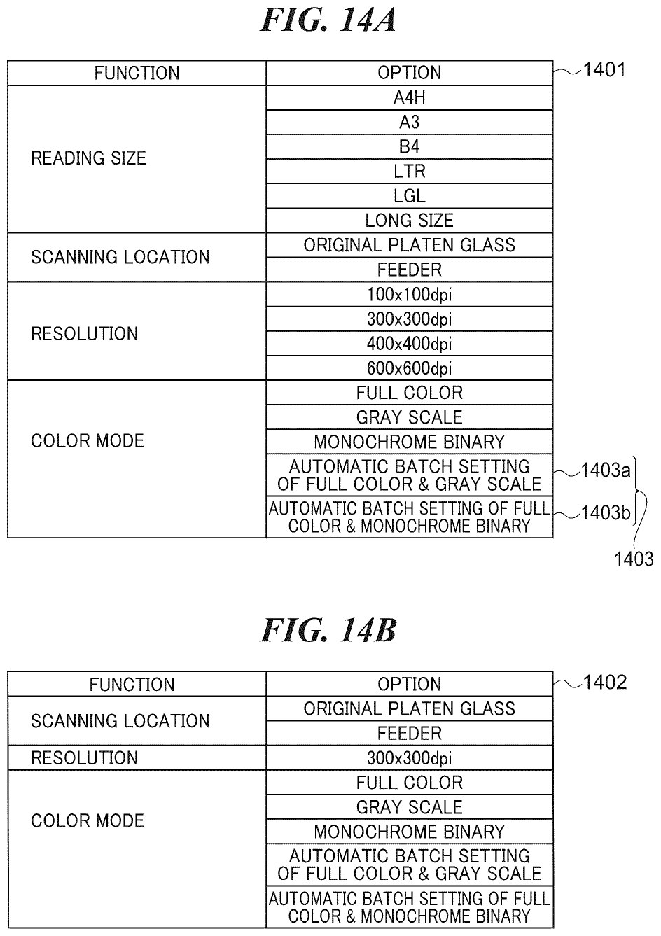

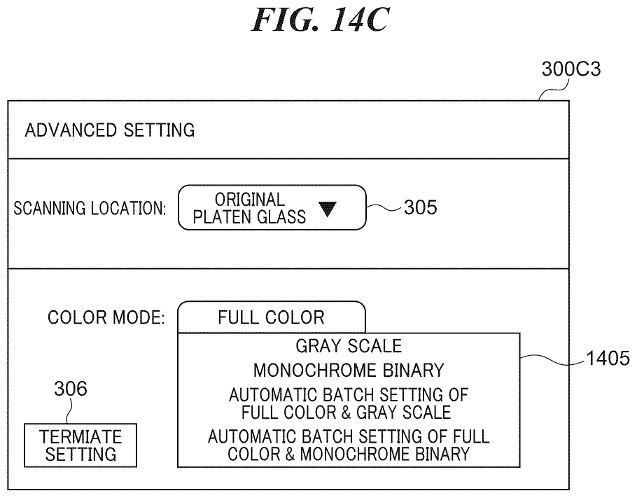

A sixth embodiment will be described below with reference to FIGS. 14A to 14C, but the description will be given mainly of different points from the above-described embodiments, and description of the same points is omitted. FIGS. 14A to 14C are diagrams associated with the scan information in the sixth embodiment. A table 1401 shown in FIG. 14A indicates an example of a list of the capabilities information acquired from the scanning device 102. As indicated in the table 1401, information 1403 can be acquired. The information 1403 is information to the effect that a plurality of options of a color mode can be collectively set. The information 1403 includes first information 1403a and second information 1403b. The first information 1403a is information to the effect that the full color mode and the gray scale mode are automatically set as batch setting. The second information 1403b is information to the effect that the full color mode and the monochrome binary mode are automatically set as batch setting. A table 1402 shown in FIG. 14B includes all scan functions which can be executed by the extension application 204 and the settings of these functions, and indicates that batch setting of the plurality of color modes can also be selected.

A detailed setting screen 300C3 shown in FIG. 14C is in a state in which batch setting of the plurality color modes can be set. On the detailed setting screen 300C3, the color mode “automatic batch setting of full color and gray scale” and the color mode “automatic batch setting of full color and monochrome binary” are included in a list 1405. For example, in a case where chromatic photo and characters are printed on an original, or a chromatic print sheet is used for the original, if, for example, “automatic batch setting of full color and gray scale” in the list 1405 is selected, this original is read in full color. With this, the scanned image is expressed in full color. Further, in a case where chromatic photo and characters are not printed on an original, and an achromatic print sheet is used for the original, this original is read in the gray scale. With this, the scanned image is expressed in the gray scale.

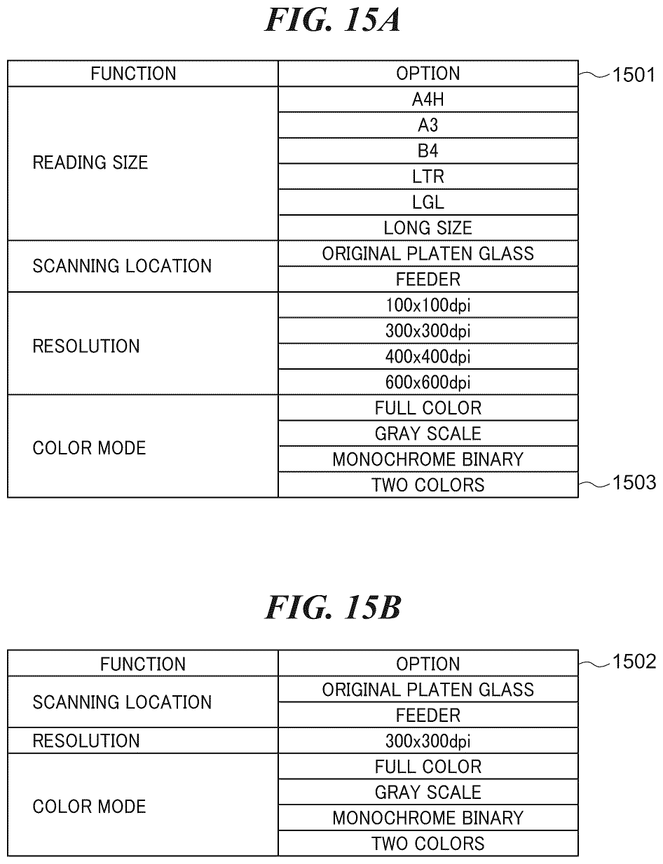

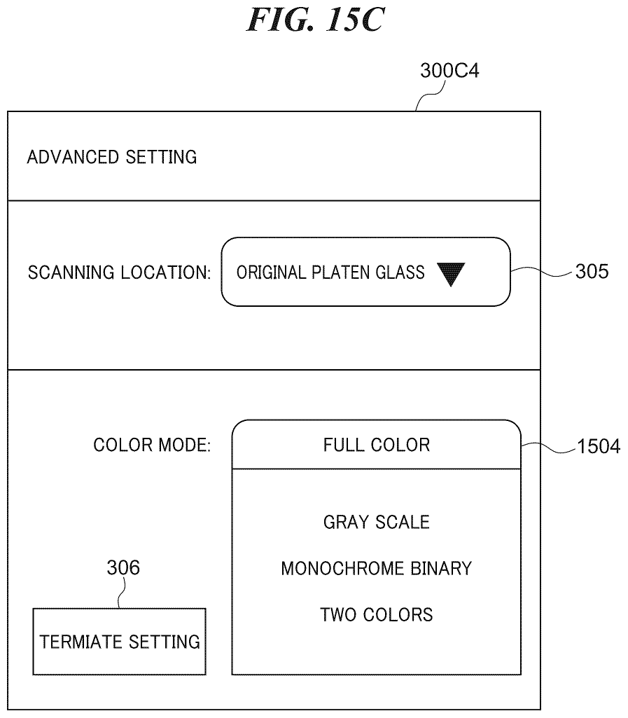

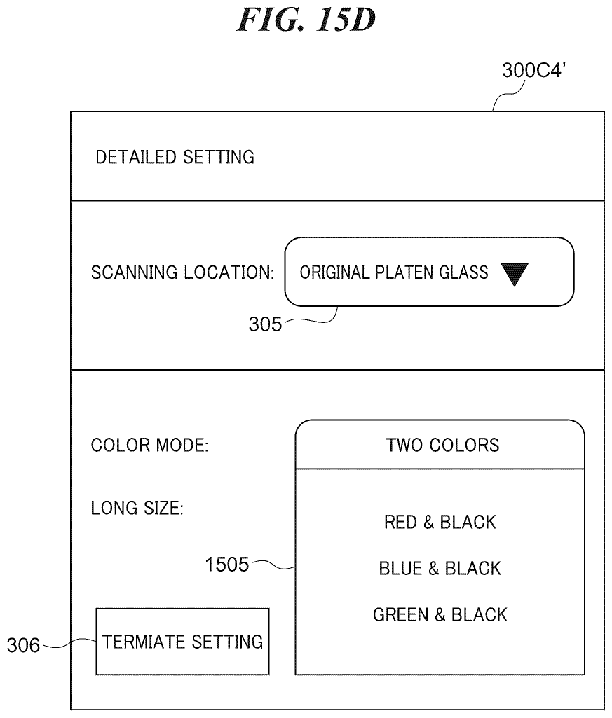

A seventh embodiment will be described below with reference to FIGS. 15A to 15D, but the description will be given mainly of different points from the above-described embodiments, and description of the same points is omitted. FIGS. 15A to 15D are diagrams associated with the scan information in the seventh embodiment. A table 1501 shown in FIG. 15A indicates an example of a list of the capabilities information acquired from the scanning device 102. As indicated in the table 1501, information 1503 can be acquired. The information 1503 is information to the effect that the color mode has an option of setting of expressing a scanned image in desired two colors (hereinafter referred to as the “two-color setting”). A table 1502 shown in FIG. 15B includes all scan functions which can be executed (supported) by the extension application 204 and the settings of these functions, and indicates that the two-color setting can also be selected.

A detailed setting screen 300C4 shown in FIG. 15C is in a state in which the two-color setting can be made. On the detailed setting screen 300C4, the color mode “two-color” is included in a list 1504. Then, in a case where “two-color” in the list 1504 is selected, the detailed setting screen 300C4 shifts to a detailed setting screen 300C4′ shown in FIG. 15D. On the detailed setting screen 300C4′ shown in FIG. 15D, a plurality of sets (options) of colors each set of which can be selected for the two-color setting are included in a list 1505. The colors which can be selected for the two-color setting are not particularly limited and include, for example, “red and black”, “blue and black”, and “green and black”. For example, in a case where “red and black” is selected, the scanned image is expressed in red and black. Note that the list 1505 on the detailed setting screen 300C4′ shown in FIG. 15D can be displayed in a grayed-out state until “two-color” is selected in the list 1504 on the detailed setting screen 300C4 shown in FIG. 15C.

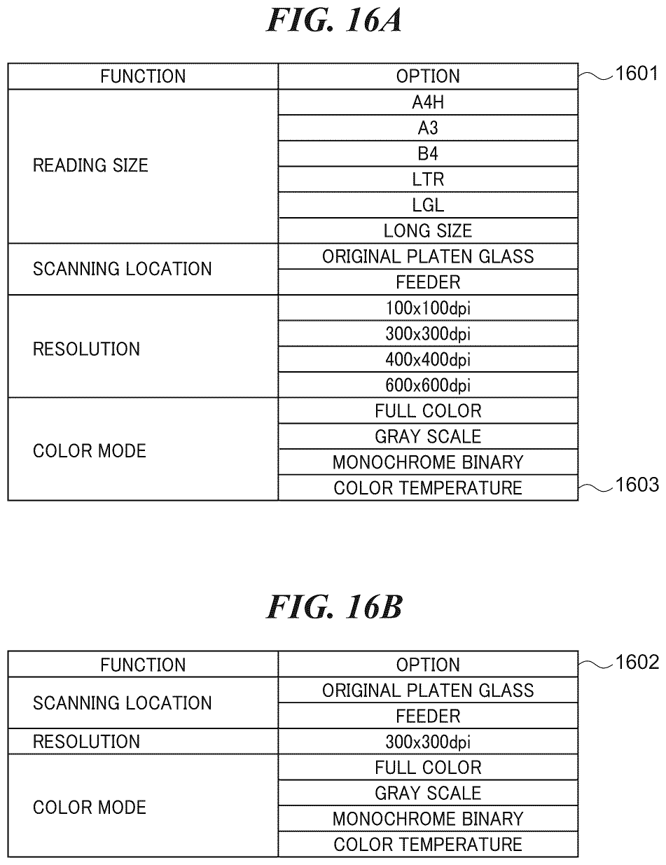

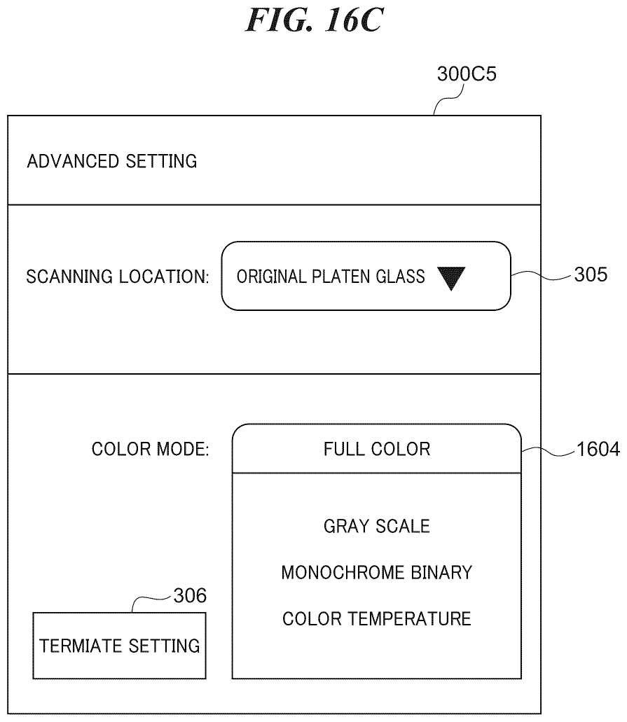

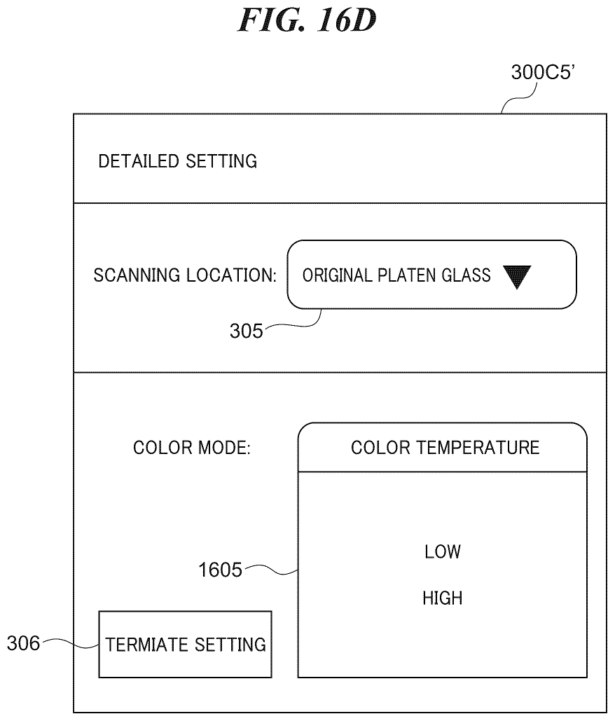

An eighth embodiment will be described below with reference to FIGS. 16A to 16D, but the description will be given mainly of different points from the above-described embodiments, and description of the same points is omitted. FIGS. 16A to 16D are diagrams associated with the scan information in the eighth embodiment. A table 1601 shown in FIG. 16A indicates an example of a list of the capabilities information acquired from the scanning device 102. As indicated in the table 1601, information 1603 can be acquired. The information 1603 is information to the effect that the color mode has an option of setting of a color temperature is enabled. A table 1602 shown in FIG. 16B includes all scan functions which can be executed (supported) by the extension application 204 and the settings (options) of these functions, and indicates that the color temperature setting can also be selected. In a case where the color temperature of scanned image data is relatively low, the scanned image becomes reddish sepia tone. On the other hand, in a case where the color temperature of scanned image data is relatively high, the scanned image becomes bluish.

A detailed setting screen 300C5 shown in FIG. 16C is in a state in which the color temperature setting can be made. On the detailed setting screen 300C5, the color mode “color temperature” is included in a list 1604. Then, in a case where “color temperature” in the list 1604 is selected, the detailed setting screen 300C5 shifts to a detailed setting screen 300C5′ shown in FIG. 16D. On the detailed setting screen 300C5′ shown in FIG. 16D, two options which can be selected in the color temperature setting are included in a list 1605. The options which can be selected in the color temperature setting are not particularly limited and include, for example, “low” and “high”. For example, in a case where “low” is selected, the scanned image becomes reddish sepia tone. Note that although, in the present embodiment, the color mode can be set based on the color temperature, this is not limitative, but for example, the color mode can be set (changed) based on a color space, such as the HSV, or can be set (changed) based on both of the color temperature and the color space.

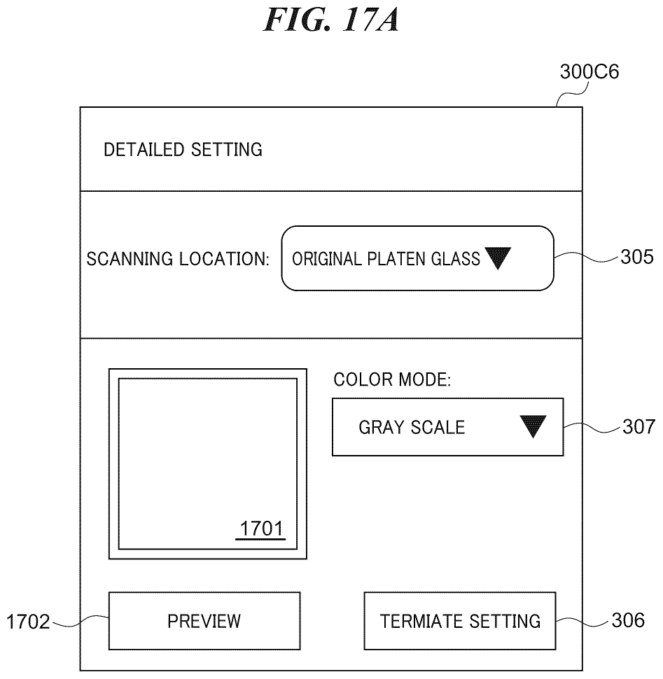

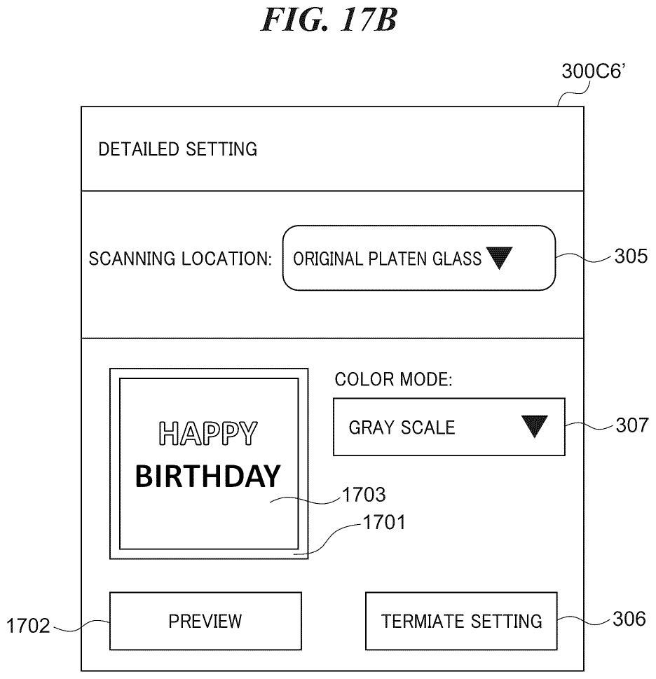

A ninth embodiment will be described below with reference to FIGS. 17A and 17B, but the description will be given mainly of different points from the above-described embodiments, and description of the same points is omitted. FIGS. 17A and 17B are diagrams each showing an example of a screen displayed on the display section of the scan system according to the ninth embodiment. A detailed setting screen 300C6 shown in FIG. 17A includes a display area 1701 for displaying a result of reading an original as a preview image and a control 1702 for instructing the display of the preview image in the display area 1701. When the control 1702 on the detailed setting screen 300C6 is operated in the state shown in FIG. 17A, the detailed setting screen 300C6 shifts to a detailed setting screen 300C6′, shown in FIG. 17B, in which a preview image 1703 is displayed in the display area 1701. This preview image 1703 can be a low-resolution image. Further, when the control 307 is operated in the state shown in FIG. 17B, it is also possible to change the color mode. With this, the preview image 1703 in the display area 1701 is updated to an image generated according to the changed color mode. The preview image 1703 at this time can be an image based on a scanned image obtained by scanning the original again or an image obtained by processing the scanned image, which has already been obtained, by the extension application 204. Then, if the preview image 1703 in the display area 1701 is an image desired by the user, the control 306 is operated.

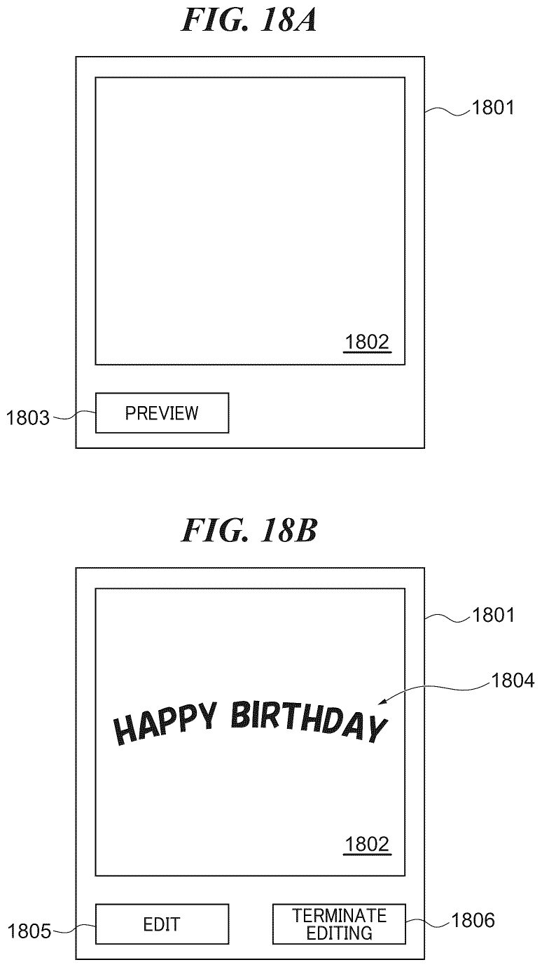

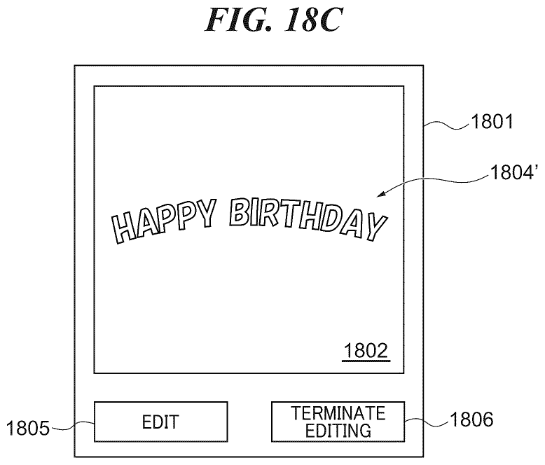

A tenth embodiment will be described below with reference to FIGS. 18A to 18C, but the description will be given mainly of different points from the above-described embodiments, and description of the same points is omitted. FIGS. 18A to 18C are diagrams each showing an example of a screen displayed on the display section of the scan system according to the tenth embodiment. FIG. 18A shows a display screen 1801 for displaying a result of reading an original as a preview image. The display screen 1801 includes a display area 1802 for displaying a preview image and a control 1803 for instructing the display of the preview image in the display area 1802. When the control 1803 is operated, the display screen 1801 shifts to a state shown in FIG. 18B. As shown in FIG. 18B, a preview image 1804 is displayed in the display area 1802 on the display screen 1801. Further, the display screen 1801 in the state shown in FIG. 18B includes a control 1805 for editing the preview image 1804 and a control 1806 for instructing termination of editing the preview image 1804. Then, when the control 1805 is operated, it is possible to edit the preview image 1804. This editing is performed by using e.g. the pointing device 117 and the keyboard 118. Let it be assumed, for example, that in a case where the preview image 1804 is a black character string of “HAPPY BIRTHDAY”, this character string is edited into a red character string of “HAPPY BIRTHDAY”. As a result, the contents edited with respect to the preview image 1804 are reflected, and as shown in FIG. 18C, an edited preview image 1804′ is displayed in the display area 1802. With this, the user can confirm the edited preview image 1804′. After confirming the edited preview image 1804′, the user can print the edited preview image 1804′ or transmit the edited preview image 1804′ by FAX or email. Note that when the control 1805 is operated, the detailed setting screen 300C shown in FIG. 3C is displayed, and full color is selected from the list 308. Then, when the control 306 is operated, the detailed setting screen 300C shifts to the display screen 1801 shown in FIG. 18C. Further, in a case where only full color can be selected from the list 308, the control 307 can be disposed in place of the control 1805. Further, as for the destination of transmission by FAX or email, in a case where transmission destinations are stored in the host computer 101, after the above-described process is completed in the host computer 101, the transmission destination can be acquired from those stored in the host computer or can be acquired from the address book of a personal computer, a smartphone, or the like. Further, a destination input screen/column can be displayed for the transmission destination. Further, in FAX transmission, two choices of the gray scale and monochrome can be selectable.

The present invention has been described heretofore based on the embodiments thereof. However, the present invention is not limited to these embodiments, but it is to be understood that the invention includes various forms within the scope of the gist of the present invention. The present invention can also be accomplished by supplying a system or an apparatus with a storage medium storing a program which realizes the functions of either of the above described embodiments, and causing one or more processors of a computer of the system or apparatus to read out and execute the program stored in the storage medium. Further, the present invention can also be accomplished by a circuit (such as an ASIC) that realizes one or more functions. Although on the detailed setting screen, as the color setting, the full color setting, the gray scale setting, the monochrome setting, and so forth can be separately received, this is not limitative. The detailed setting screen is only required to be capable of receiving at least one of these settings or can be configured to be capable of receiving a plurality of desired settings.

Further, there is a case where an original read by the scanning device 102 is an original in a blank state. Then, the extension application 204 (or the general-purpose scan software 202) is preferable to be capable of determining whether or not an original read by the scanning device 102 is an original in a blank state. In this case, before the determination performed by the extension application 204, it is necessary to perform temporary scanning step for once scanning an original in the scanning device 102. Then, if it is determined that the original read by the scanning device 102 is not an original in a blank state, the final scanning step for scanning the original with the color setting received on the detailed setting screen 300C is performed in the scanning device 102. On the other hand, if it is determined that the original read by the scanning device 102 is an original in a blank state, it is preferable to omit the final scanning step. With this, it is possible to prevent a wasteful execution of the final scanning step.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-044805 filed Mar. 21, 2024, which is hereby incorporated by reference herein in its entirety.

What is claimed is:

1. A non-transitory computer-readable storage medium storing a program for supporting a general-purpose program which can be commonly used for scanners of a plurality of makers,
wherein the program causes a computer to:
display a setting reception screen for receiving setting of colors expressing an image read by the scanner; and
output a reading instruction for causing the scanner to read the image under the color setting received on the setting reception screen.

2. The storage medium according to claim 1, wherein the program causes the computer to determine whether or not an image read by the scanner is an image of an original in a blank state.

3. The storage medium according to claim 2, wherein as a result of the determination of whether or not an image read by the scanner is an image of an original in a blank state, in a case where it is determined that the image read by the scanner is not an image of an original in a blank state, the program causes the computer to output the reading instruction, whereas in a case where it is determined that the image read by the scanner is an image of an original in a blank state, the program omits causing the computer to output the reading instruction.

4. The storage medium according to claim 1, wherein on the setting reception screen, the program causes the computer to receive, as the color setting, at least one setting out of a setting of expressing the image in full color, a setting of expressing the image in gray scale, a setting of expressing the image in monochrome, and a setting of expressing the image in a desired color.

5. The storage medium according to claim 4, wherein the setting of expressing the image in a desired color includes a plurality of options which enable color selection.

6. The storage medium according to claim 4, wherein when displaying the setting reception screen, the program causes the computer to switch the color setting according to the image.

7. The storage medium according to claim 1, wherein on the setting reception screen, as the color setting, it is possible to perform setting based on at least one of a color temperature and a color space.

8. The storage medium according to claim 1, wherein the setting reception screen includes a determination operation section for determining termination of the color setting.

9. The storage medium according to claim 8, wherein in a case where the determination operation section is operated, the program causes the computer to output the reading instruction.

10. The storage medium according to claim 1, wherein the program can switch whether or not to cause the computer to display the setting reception screen according to the scanner.

11. The storage medium according to claim 1, wherein the program causes the computer to display a result of reading the image according to the reading instruction, as a preview image.

12. The storage medium according to claim 1, wherein on the setting reception screen, as the color setting, the program can cause the computer to receive a full color setting for expressing the image in full color, a gray scale setting for expressing the image in gray scale, a monochrome setting for expressing the image in monochrome, or a desired color setting for expressing the image in a desired color, and can cause the computer to update the preview image to an image processed according to the full color setting, the gray scale setting, the monochrome setting, or the desired color setting.

13. The storage medium according to claim 11, wherein the preview image is configured to be editable.

14. The storage medium according to claim 11, wherein as the general-purpose program, the program supports a program for causing the scanners of the plurality of makers to execute a commonly executable instruction.

15. A control method of performing control to support a general-purpose program which can be commonly used for scanners of a plurality of makers, comprising:
displaying a setting reception screen for receiving setting of colors expressing an image read by the scanner; and
outputting a reading instruction for causing the scanner to read the image under the color setting received on the setting reception screen.

16. An information processing apparatus that is communicably connected to scanners of a plurality of makers and is capable of processing information with the scanners, comprising:
a general-purpose program that can be commonly used for the scanners of the plurality of makers; and
a program for supporting the general-purpose program,
wherein the program causes a computer to:
display a setting reception screen for receiving setting of colors expressing an image read by the scanner; and
output a reading instruction for causing the scanner to read the image under the color setting received on the setting reception screen.
